(19) United States
(12) Patent Application Publication
(10) Pub. No.: US 2024/0160023 A1
(43) Pub. Date: May 16, 2024

(54) PROTECTION OF AUGMENTED REALITY (AR) DISPLAY IN NEAR-EYE DISPLAY DEVICE

(71) Applicant: Meta Platforms Technologies, LLC, Menlo Park, CA (US)

(72) Inventors: Kyung Won PARK, Bellevue, WA (US); Jie LUO, Fremont, CA (US); Firmansyah SULEM, San Jose, CA (US); Duming Zhang, Union City, CA (US); Kian KERMAN, Monte Sereno, CA (US); William CHANG, Fremont, CA (US); Chandra Sekhar KAKANI, Fremont, CA (US); Erdem ERDEN, Duvall, WA (US); Difei QI, Bellevue, WA (US); Yu SHI, Redmond, WA (US); Ningfeng HUANG, San Jose, CA (US); Mehmet Emre YAVUZ, Portland, OR (US)

(73) Assignee: Meta Platforms Technologies, LLC, Menlo Park, CA (US)

(21) Appl. No.: 18/477,235

(22) Filed: Sep. 28, 2023

Related U.S. Application Data
(60) Provisional application No. 63/429,646, filed on Dec. 2, 2022.
(60) Provisional application No. 63/425,992, filed on Nov. 16, 2022.
(60) Provisional application No. 63/431,198, filed on Dec. 8, 2022.
(60) Provisional application No. 63/448,046, filed on Feb. 24, 2023.

(51) Int. Cl. G02B 27/01

(52) U.S. Cl. CPC G02B 27/0172; G02B 2027/0178

(57) ABSTRACT

A display element of an optical stack assembly in an augmented reality (AR) near-eye display device may be protected against ultraviolet (UV) and/or infrared (IR) exposure through one or more protective coatings on various surfaces of the elements of the optical stack assembly. A photochromic coating on one of the surfaces of the elements of the optical stack assembly may also be used instead of or in addition to the protective coatings.

### TECHNICAL FIELD

First section of this patent application relates generally to near-eye display devices, and in particular, to protection of augmented reality (AR) displays in near-eye display devices against ultraviolet (UV) light exposure.

Second section of this patent application relates generally to waveguide structures, and more specifically, to fabrication of gradient height, slanted waveguide structures through nanoimprint lithography for virtual reality (VR)/augmented reality (AR) applications.

Third section of this patent application relates generally to testing and calibration of wearable display devices, and in particular, to a variable interpupillary distance (IPD) multi-function test system (periscope) for disparity and modulation transfer function (MTF) measurement of wearable display devices.

Fourth section of this patent application relates generally to waveguide displays, and in particular, improving efficiency of waveguide display architecture design process by using parametric artificial gratings instead of physical gratings.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. In some examples, the head-mounted display (HMD) device may project or direct light to may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment. Head-mounted display (HMD) devices may also present interactive content, where a user's (wearer's) gaze may be used as input for the interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIGS. 3A and 3B illustrate a perspective view and a top view of a near-eye display in the form of a pair of glasses, according to an example.

FIG. 4A illustrates effects of photochromic darkening on eyeglasses in protection against ultraviolet (UV) exposure.

FIG. 4B illustrates effects of ultraviolet (UV) blocking coating on eyeglasses in protection against ultraviolet (UV) exposure.

FIG. 5 illustrates a top view of an optical stack assembly including a display layer for use in a near-eye display device, according to an example.

FIG. 6A illustrates effects of ultraviolet (UV) exposure on a display within an optical stack assembly.

FIG. 6B illustrates potential application surfaces of protective coating within an optical stack assembly, according to examples.

FIG. 7 illustrates a flow diagram of a method for making a near-eye display device with one or more protective coating layers within an optical stack assembly, according to some examples.

FIGS. 8 to 12 illustrate aspects concerning Section II—System and Method For Gradient Height Slanted Waveguide Fabrication Through Nanoimprint Lithography, of the present disclosure.

FIGS. 13 to 16 illustrate aspects concerning Section III—Variable Interpupillary Distance (IPD) Multi-Function Test System For Wearable Display Devices, of the present disclosure.

FIGS. 17A to 21B illustrate aspects concerning Section IV—Parametric Artificial Gratings For a Waveguide Display Architecture, of the present disclosure.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Near-eye display devices such as augmented reality (AR) glasses provide artificial content superimposed with a real environment view. Some implementations of such devices include a transparent display along with any number of optical components (e.g., optical lenses, polarizers, etc.), where the display provides the artificial content to an eye box superimposed with light from the environment passing through the display. In other implementations, a view of the environment may be captured by one or more cameras on an external surface of the augmented reality (AR) glasses and superimposed with the artificial content at the display. When the augmented reality (AR) glasses are used outdoors, ultraviolet (UV) and/or infrared (IR) light from the sun may cause damage on the display. In some cases, one or more optical elements may focus the ultraviolet (UV) and/or infrared (IR) light at particular locations on the display and cause even more damage.

In some examples of the present disclosure, a display element of an optical stack assembly in an augmented reality (AR) near-eye display device may be protected against ultraviolet (UV) and/or infrared (IR) exposure through one or more protective coatings on various surfaces of the elements of the optical stack assembly. In other examples, a photochromic coating on one of the surfaces of the elements of the optical stack assembly may be used instead of or in addition to the protective coatings.

While some advantages and benefits of the present disclosure are apparent, other advantages and benefits may include increased product life for augmented reality (AR) glasses, prevention of performance reduction due to damage by the ultraviolet (UV) and/or infrared (IR) exposure, and ease of manufacture of protected augmented reality (AR) glasses.

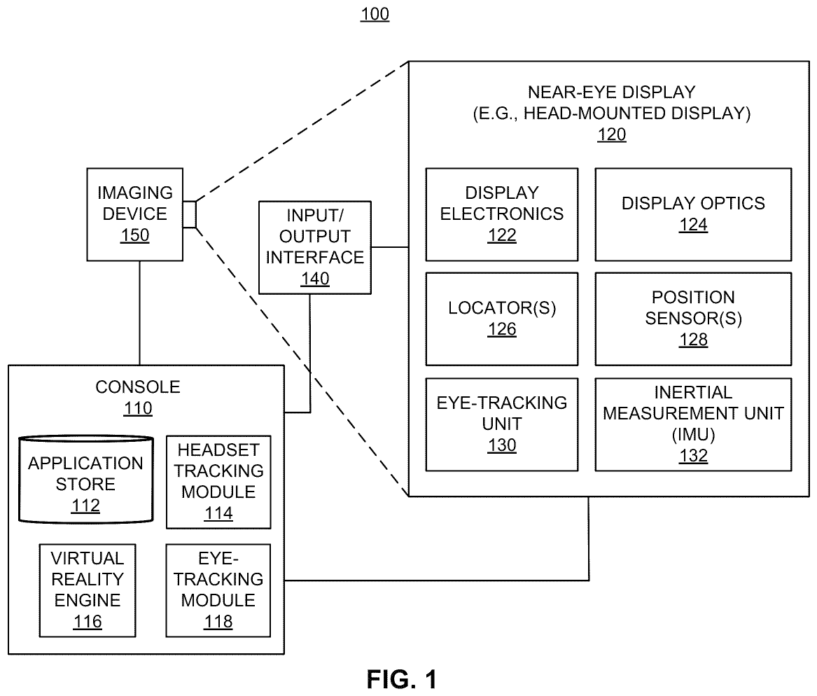

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

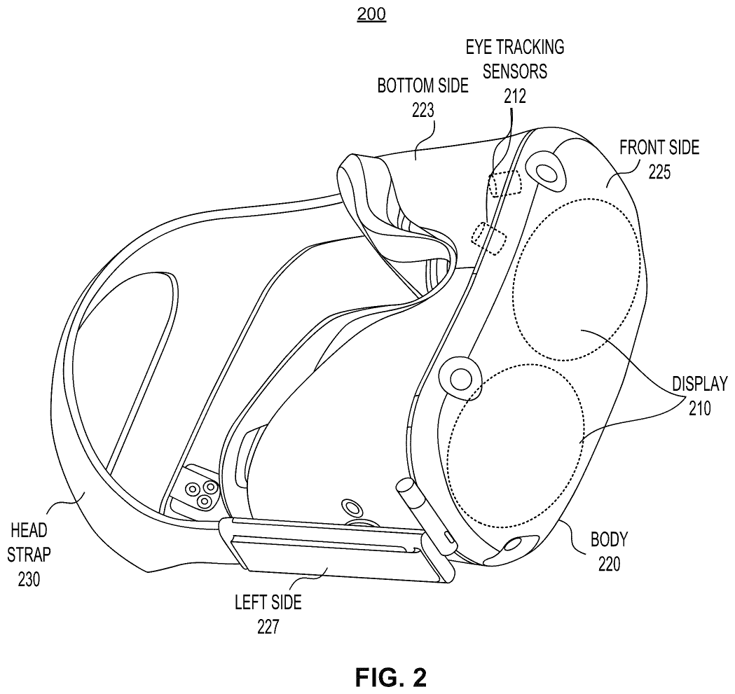

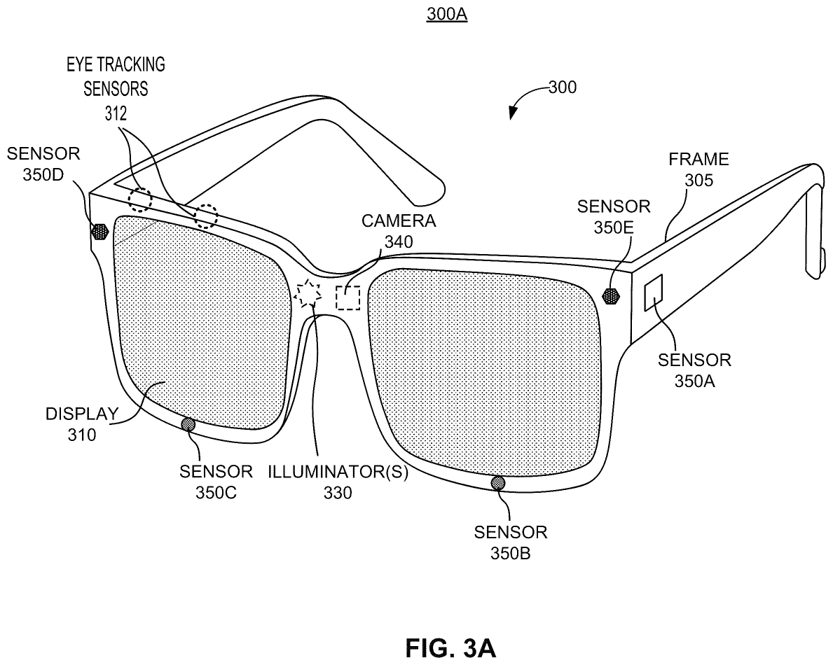

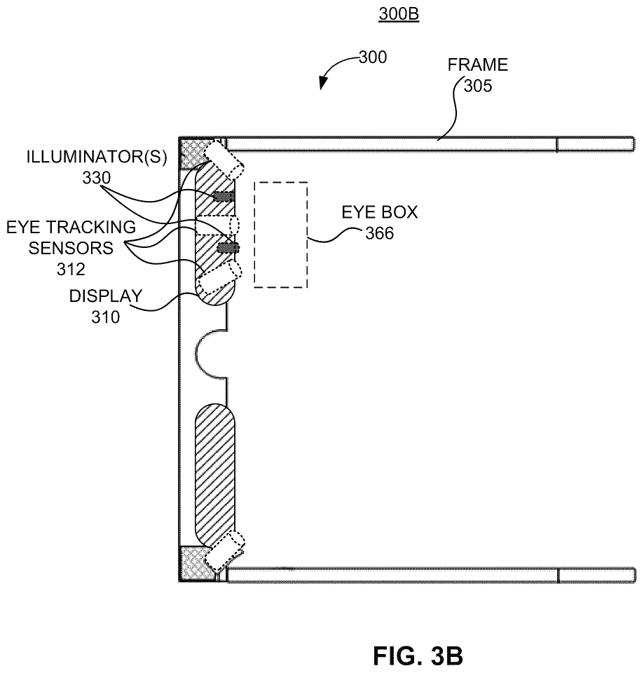

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). The fringe image may be projected onto the eye by a projector. A structured image may also be projected onto the eye by a micro-electromechanical system (MEMS) based scanner reflecting light (e.g., laser light) from a light source. In other examples, the eye tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head-mounted device (HMD) device 200 may be a part of a virtual reality (VR) system, an augmented reality (AR) system, a mixed reality (MR) system, another system that uses displays or wearables, or any combination thereof. In some examples, the head-mounted display (HMD) device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components.

In some examples, the head-mounted display (HMD) device 200 may present, to a user, media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface 140 for communicating with a console 110, as described with respect to FIG. 1. In some examples, the head-mounted display (HMD) device 200 may include a virtual reality engine (not shown), but similar to the virtual reality engine 116 described with respect to FIG. 1, that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine 116 may be used for producing a signal (e.g., display instructions) to the one or more display assemblies. In some examples, the head-mounted display (HMD) device 200 may include locators (not shown), but similar to the locators 126 described in FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

In some examples, the projector may provide a structured light (e.g., a fringe pattern) onto the eye which may be captured by the eye tracking sensors 212. The eye tracking sensors 212 or a communicatively coupled processor (e.g., eye tracking module 118 in FIG. 1) may analyze the captured reflection of the fringe pattern and analyze to generate a phase map of the fringe pattern, which may provide depth information for the eye and its structures. In other examples, the projector may be a combination of a laser source and a micro-electromechanical system (MEMS) based 2D scanner.

FIG. 3A is a perspective view 300A of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc. In other examples, the display 210 may include a projector, or in place of the display 310 the near-eye display 300 may include a projector.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications. The near-eye display 300 may also include eye tracking sensors 312.

FIG. 3B is a top view 300B of a near-eye display 300 in the form of a pair of glasses (or other similar eyewear), according to an example. In some examples, the near-eye display 300 may include a frame 305 having a form factor of a pair of eyeglasses. The frame 305 supports, for each eye: a fringe projector 314 such as any fringe projector variant considered herein, a display 310 to present content to an eye box 366, eye tracking sensors 312, and one or more illuminators 330. The illuminators 330 may be used for illuminating an eye box 366, as well as, for providing glint illumination to the eye. A fringe projector 314 may provide a periodic fringe pattern onto a user's eye. The display 310 may include a pupil-replicating waveguide to receive the fan of light beams and provide multiple laterally offset parallel copies of each beam of the fan of light beams, thereby extending a projected image over the eye box 366.

In some examples, the pupil-replicating waveguide may be

transparent or translucent to enable the user to view the outside world together with the images projected into each eye and superimposed with the outside world view. The images projected into each eye may include objects disposed with a simulated parallax, so as to appear immersed into the real-world view.

In some examples, the image processing and eye position/orientation determination functions may be performed by a central controller, not shown, of the near-eye display 300. The central controller may also provide control signals to the display 310 to generate the images to be displayed to the user, depending on the determined eye positions, eye orientations, gaze directions, eyes vergence, etc.

In some examples, the display 310 may be a transparent display and present artificial content (e.g., computer generated images “CGI”) which the user may see superimposed with a view of the environment presented by light passing through the transparent display 310 (and the remaining elements of the optical stack assembly). The other optical elements of the optical stack assembly may include optical lenses, a phase plate, one or more polarizers, etc. In a near-eye display device in form of glasses, the optical stack assembly (along with it, the display 310) may be exposed to ultraviolet (UV) and/or infrared (IR) light from the sun or artificial light sources (e.g., an ultraviolet (UV light). The ultraviolet (UV) and/or infrared (IR) exposure may damage the display 310 by causing molecular level changes or by causing heat build-up. In some cases, one or more optical elements (e.g., optical lenses) in the optical stack assembly may focus the ultraviolet (UV) and/or infrared (IR) light on particular locations on the display 310, further increasing the damage. If not mitigated, the ultraviolet (UV) and/or infrared (IR) exposure may also damage a user's eye.

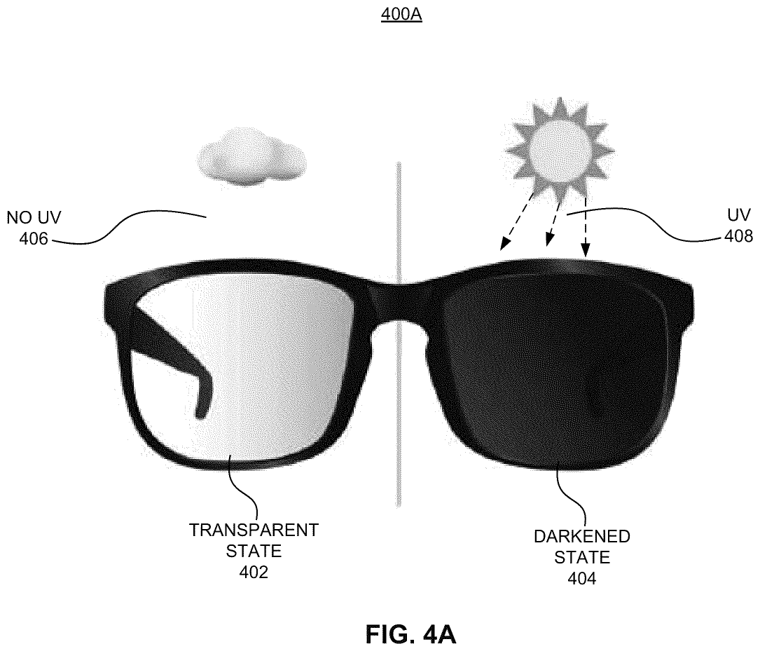

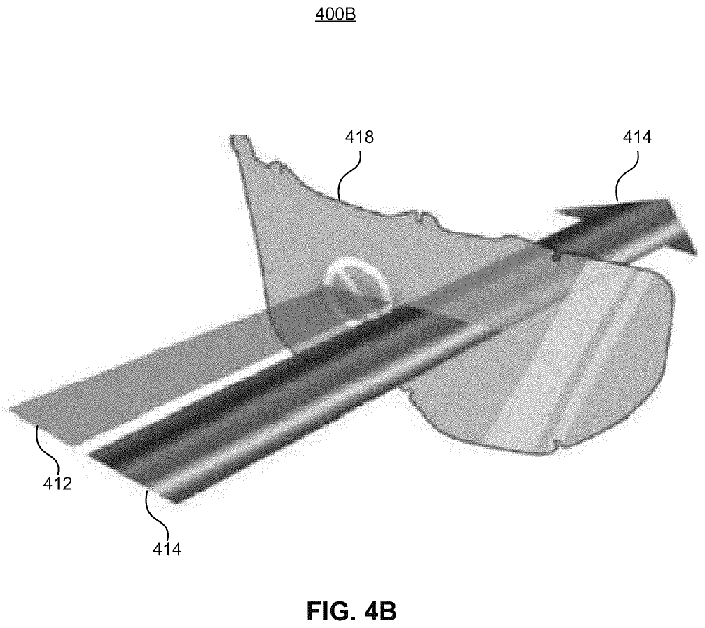

FIG. 4A illustrates effects of photochromic darkening on eyeglasses in protection against ultraviolet (UV) exposure. Diagram 400A shows one mitigation approach against ultraviolet (UV) and/or infrared (IR) exposure. A lens of a pair of glasses treated with a photochromic coating may be in a transparent state 402 when there is no ultraviolet (UV) and/or infrared (IR) light presence 406 (or the exposure is below a particular threshold). When the ultraviolet (UV) and/or infrared (IR) exposure exceeds a particular threshold (408), the photochromic coating may change the lens to a darkened state 404 reducing ultraviolet (UV) and/or infrared (IR) exposure to the eye of the wearer (as well as an inside surface of the lens).

Photochromic coating may be achieved through a number of approaches. For example, glass optical lenses may have their photochromic properties through embedded microcrystalline silver halides (e.g., silver chloride) in the glass. Plastic photochromic lenses may use organic photochromic molecules (e.g., oxazines such as dioxazines or benzoxazines and naphthopyrans) to achieve the reversible darkening effect. Overall, inorganic or organometallic compounds such as metal oxides, alkaline earth, sulfides, titanates, metal halides, and some transition metal compounds such as the carbonyls may exhibit photochromic properties. On the organic compounds side, some anilines, disulfoxides, hydrazones, osazones, semicarbazones, stilbene derivatives, succinic anhydride, camphor derivatives, o-nitrobenzyl derivatives and spiro compounds have been shown to have photochromic properties.

FIG. 4B illustrates effects of ultraviolet (UV) blocking coating on eyeglasses in protection against ultraviolet (UV) exposure. Diagram 400B shows a mitigation approach against ultraviolet (UV) exposure through mitigation approach against ultraviolet (UV) blocking coating. As shown in the diagram, the light from the sun is composed of visible light 414 (different wavelengths corresponding to different colors) and ultraviolet (UV) portion 412 (i.e., 280 to 400 nanometers). Ultraviolet (UV) blocking coating 418 may pass the visible light 414 through while blocking the ultraviolet (UV) portion 412.

Ultraviolet (UV) coating may be implemented using certain polymers or nano-compounds. Furthermore, transparent conductive oxide (TCO), aluminum doped zinc oxide (AZO), indium tin oxide (ITO), indium zinc oxide (IZO) may also be used as coating material. Ultraviolet light comprises two wavelength ranges: 280-315 nanometers for medium-wave UV (UV-B) and 315-400 nanometers for long-wave UV (UV-A). Infrared (IR) light may also cause heat build-up due to its energy and cause damage similar to the ultraviolet (UV) light. Infrared (IR) light exposure may be mitigated by applying coatings similar to the ultraviolet (UV) coatings.

In some examples, complete or partial ultraviolet (UV) blocking may be achieved through the use of an ultraviolet blocking material in one of the elements of the optical assembly (e.g., optical lens) such as polycarbonate (PC), acrylic, polymethyl methacrylate (PMMA), etc. (usually blocking ultraviolet (UV) <380 nm). Additionally, infrared (IR) blocking coating may be applied providing both UV and IR blocking. Infrared (IR) cutoff coating may be provided, in some examples, as a thin film stack with two alternating materials with different refractive index.

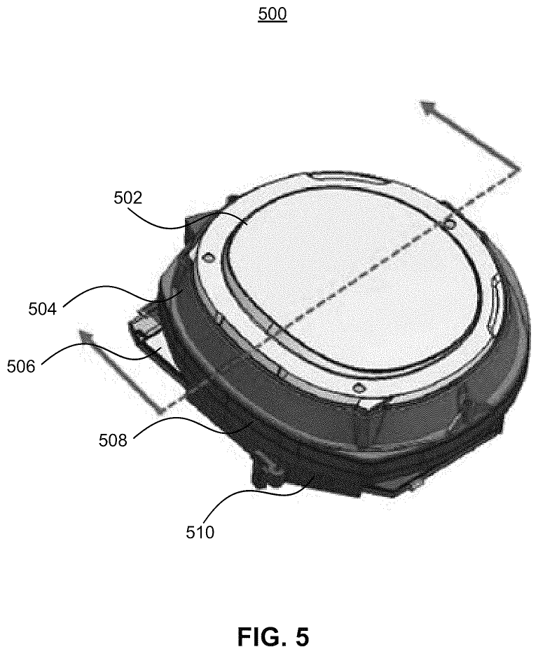

FIG. 5 illustrates a top view of an optical stack assembly including a display layer for use in a near-eye display device, according to an example. Diagram 500 shows a top layer 502m a second layer 504, a third layer 508, and a fourth layer 506 encased within a mechanical support 510 of the optical stack assembly. The layers may include any number of optical elements. For example, fourth layer 506 may be a transparent display to provide artificial content to the eye box. The other layers may include optical lenses (also referred to as virtual reality “VR” lenses) to add optical power by focusing the presented artificial content, polarizers, optical correction lenses, phase plates, and comparable elements. Some of the layers may be in contact with at least one other layer, while some of the layers may have an airgap between them.

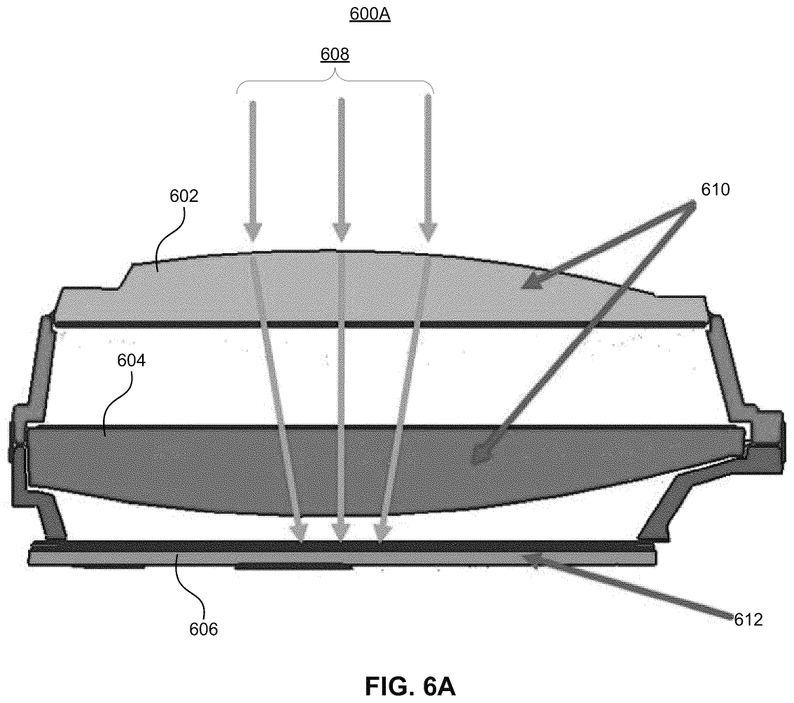

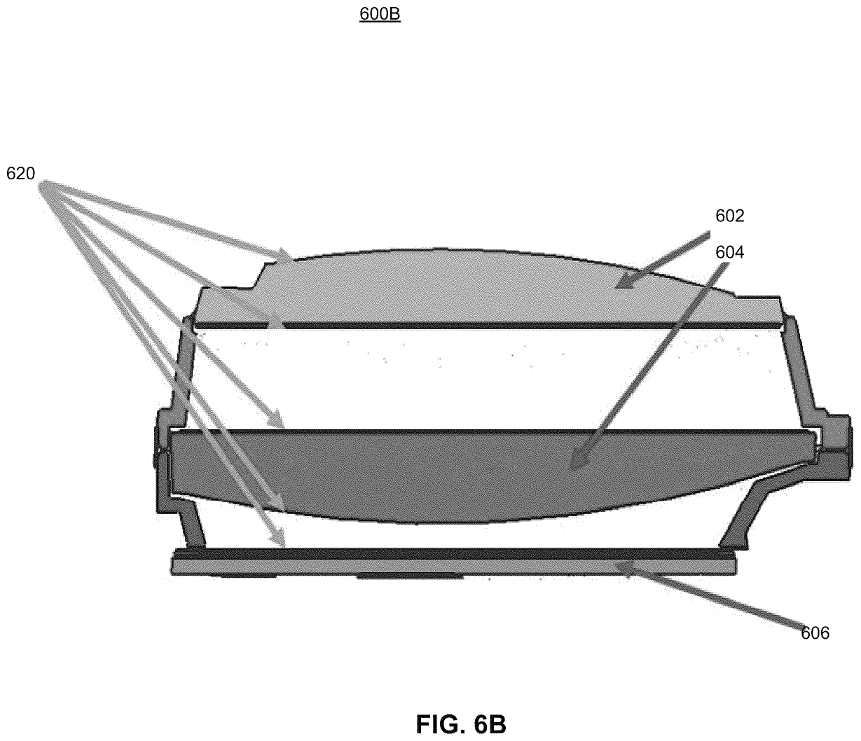

FIG. 6A illustrates effects of ultraviolet (UV) exposure on a display within an optical stack assembly. Diagram 600A shows an example implementation of an optical stack assembly with display 606 and virtual reality (VR) lenses 604 and 602. As discussed above the optical stack assembly may include additional layers with similar or other optical elements. The elements of the optical stack assembly may have airgaps between them.

In some examples, ultraviolet (UV) and/or infrared (IR) light 608 from the sun may enter the optical stack assembly through the first virtual reality (VR) lens 602, pass through the second virtual reality (VR) lens 604, and reach a surface 612 of the display 606. The ultraviolet (UV) and/or infrared (IR) light 608 may be focused by the virtual reality (VR) lenses 602 and 604 causing degradation or damage to the surface 612 of the display 606.

FIG. 6B illustrates potential application surfaces of protective coating within an optical stack assembly, according to examples. Diagram 600B shows various ultraviolet (UV) and/or infrared (IR) exposure mitigation possibilities. Any of the surfaces 620 of the virtual reality (VR) lenses 602 and 604 and the display 606 may be treated with ultraviolet (UV) and/or infrared (IR) blocking coating or photochromic coating as discussed herein.

In some examples, the photochromic coating may change to a darkened state in the presence of ultraviolet (UV) and/or infrared (IR) light preventing sufficient ultraviolet (UV) and/or infrared (IR) light from reaching the display 606 and causing damage or degradation. Similarly, ultraviolet (UV) and/or infrared (IR) blocking coating(s) may prevent sufficient ultraviolet (UV) and/or infrared (IR) light from reaching the display 606 and causing damage or degradation. In some implementations, the ultraviolet (UV) and/or infrared (IR) blocking coating and photochromic coating may be used together for stronger protection.

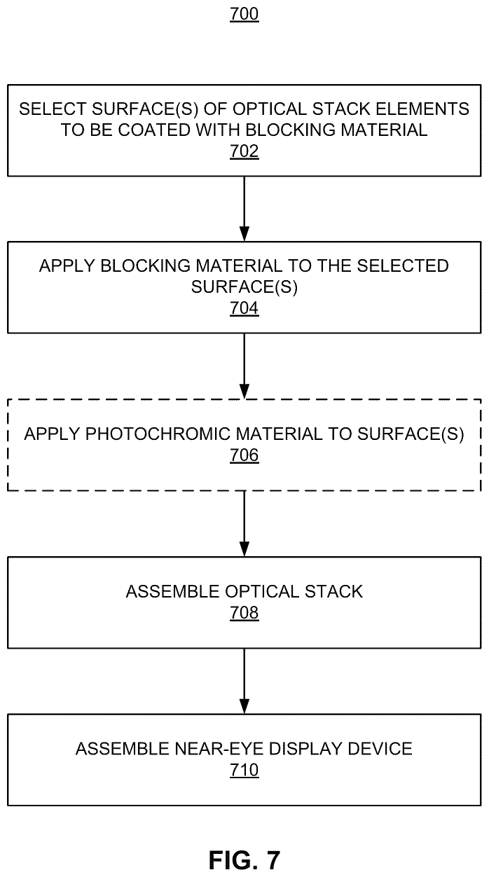

FIG. 7 illustrates a flow diagram of a method 700 for making a near-eye display device with one or more protective coating layers within an optical stack assembly, according to some examples. The method 700 is provided by way of example, as there may be a variety of ways to carry out the method described herein. Although the method 700 is primarily described as being performed to fabricate the components of FIG. 3B and 6B, the method 700 may be executed or otherwise performed by one or more processing components of a fabrication system or a combination of systems to make similar optical stack assemblies and near-eye displays. Each block shown in FIG. 7 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 702, surfaces (outer or inner) of one or more optical elements of an optical stack assembly may be selected for application of ultraviolet (UV) and/or infrared (IR) blocking coating. Depending on coating type, thickness, and designated protection level, one surface may be selected or multiple surfaces may be selected.

At block 704, the selected surface(s) of the optical elements of the optical stack assembly may be treated with ultraviolet (UV) and/or infrared (IR) blocking material. The ultraviolet (UV) and/or infrared (IR) blocking material may be applied as a thin layer of coating through spraying, deposition, or similar methods. The material may also be applied through infusion into the surface of the optical element. In some cases, the optical element may be embedded entirely or partially with the ultraviolet (UV) and/or infrared (IR) blocking material.

At optional block 706, photochromic material may be applied to one or more surfaces of selected optical elements of the optical stack assembly. The photochromic material may also be applied through infusion into the surface of the optical element. In some cases, the photochromic material may be applied as a thin layer of coating through spraying, deposition, or similar methods. The material may also be applied through infusion into the surface of the optical element. In some cases, an optical element may be embedded entirely or partially with the photochromic material.

At block 708, the optical stack assembly may be put together by assembling the individual optical elements inside a mechanical support structure. Some optical elements may be an airgap between them, while others may have touching surfaces.

At block 710, a near-eye display device (e.g., augmented reality (AR) glasses) may be assembled by connecting other components such as the frame, any electronic components (e.g., sensors, camera, illuminators, battery, controller, etc.)

According to examples, a method of making an optical stack assembly for a near-eye display device with ultraviolet (UV) and/or infrared (IR) protection is described herein. A system of making the optical stack assembly is also described herein. A non-transitory computer-readable storage medium may have an executable stored thereon, which when executed instructs a processor to perform the methods described herein.

### Section II

### System and Method for Gradient Height Slanted Waveguide Fabrication Through Nanoimprint Lithography

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

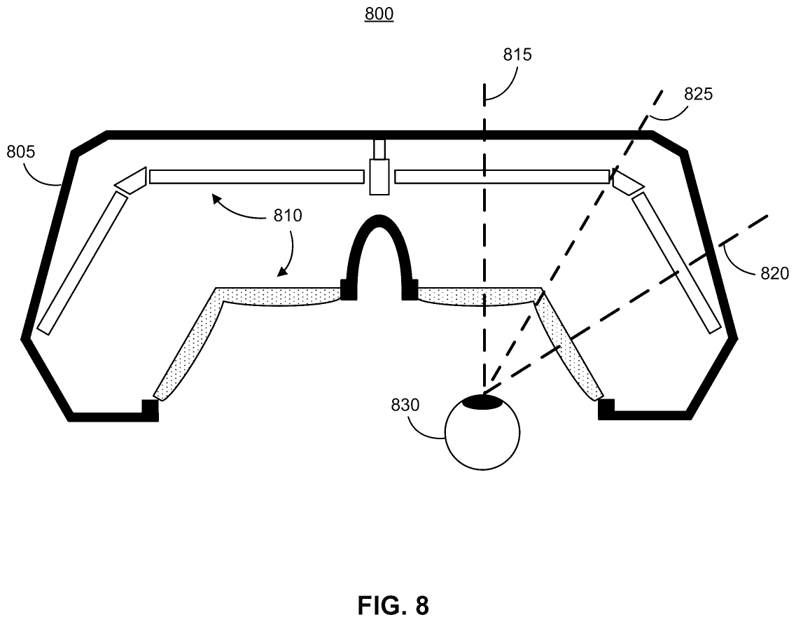

FIG. 8 illustrates a cross section view of simplified version of a head-mounted display (HMD) using tiled optics, according to an example.

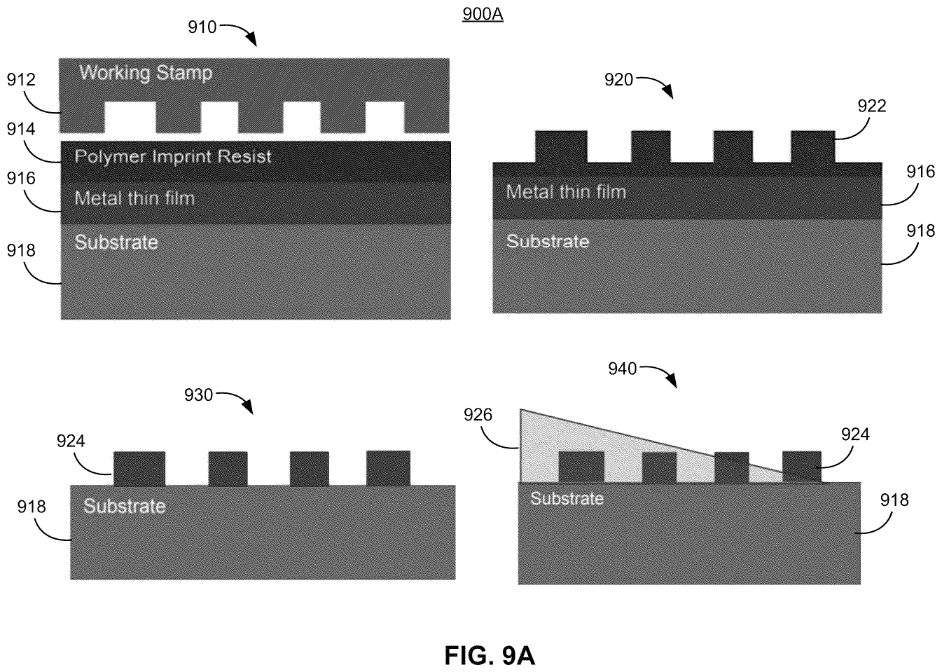

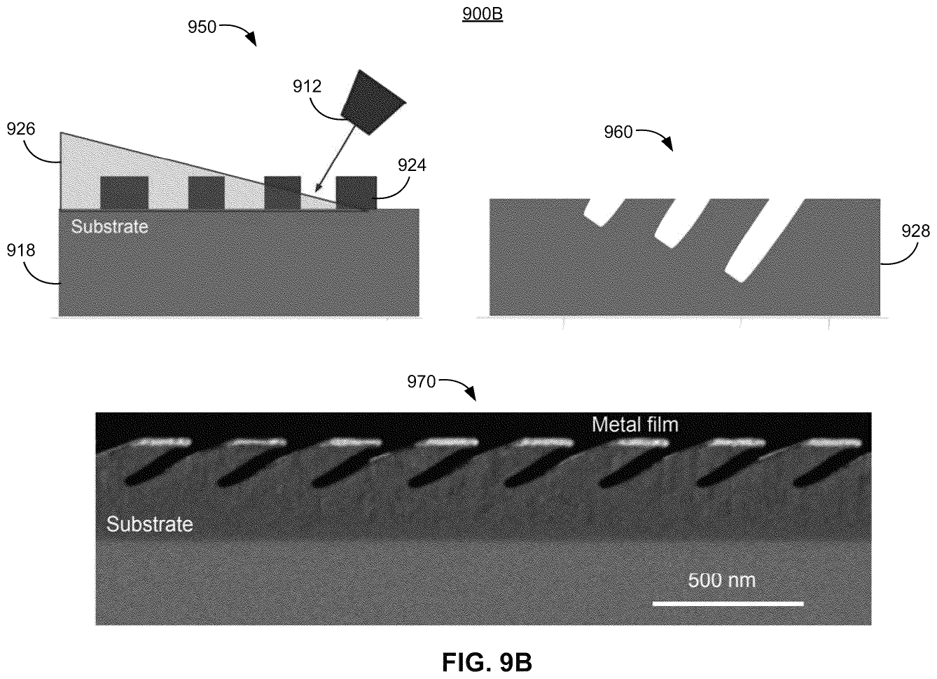

FIGS. 9A-9B illustrate various steps in a conventional slanted waveguide structure fabrication using an etch process.

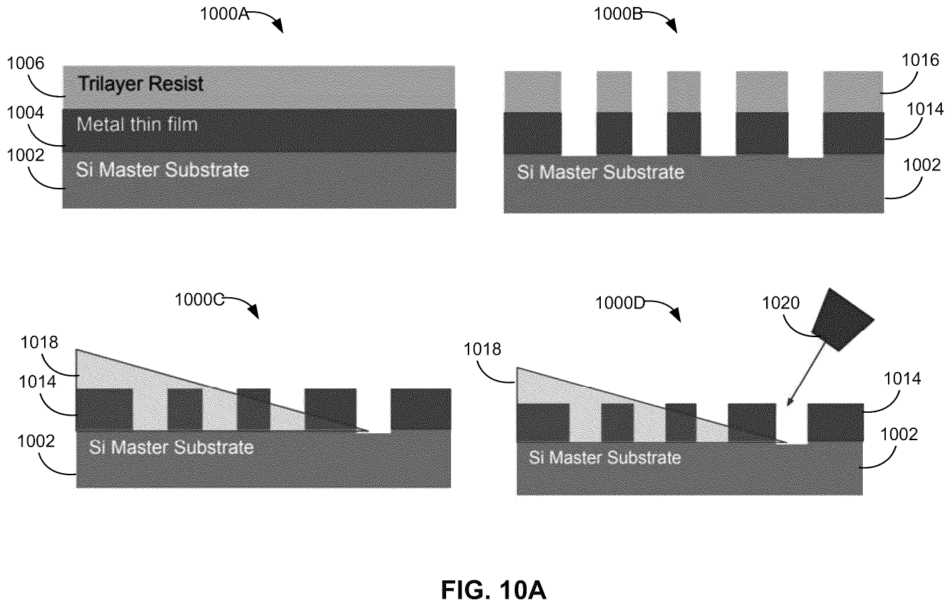

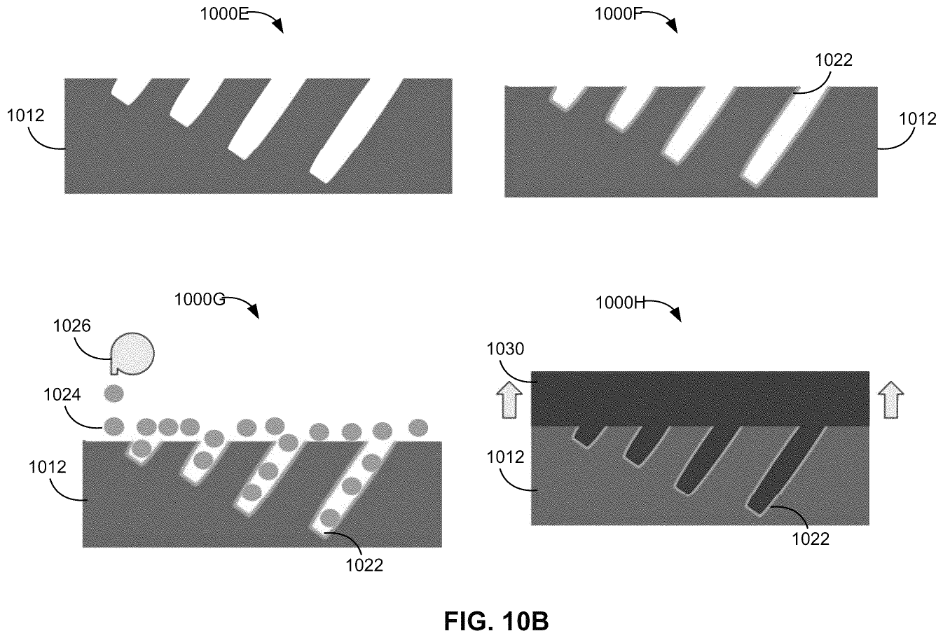

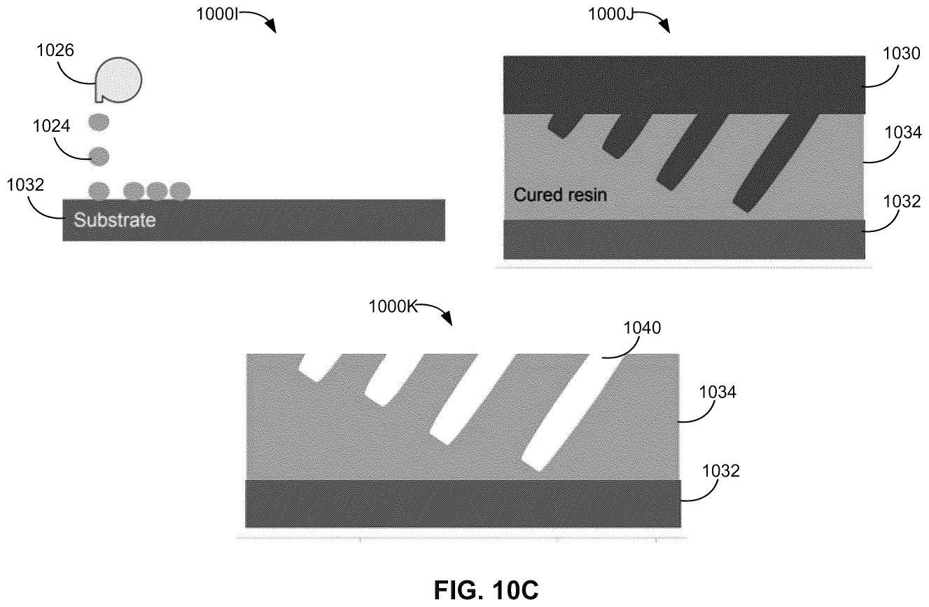

FIGS. 10A-10C illustrate various steps in a gradient height, slanted waveguide structure fabrication using nanoimprint lithography, according to some examples.

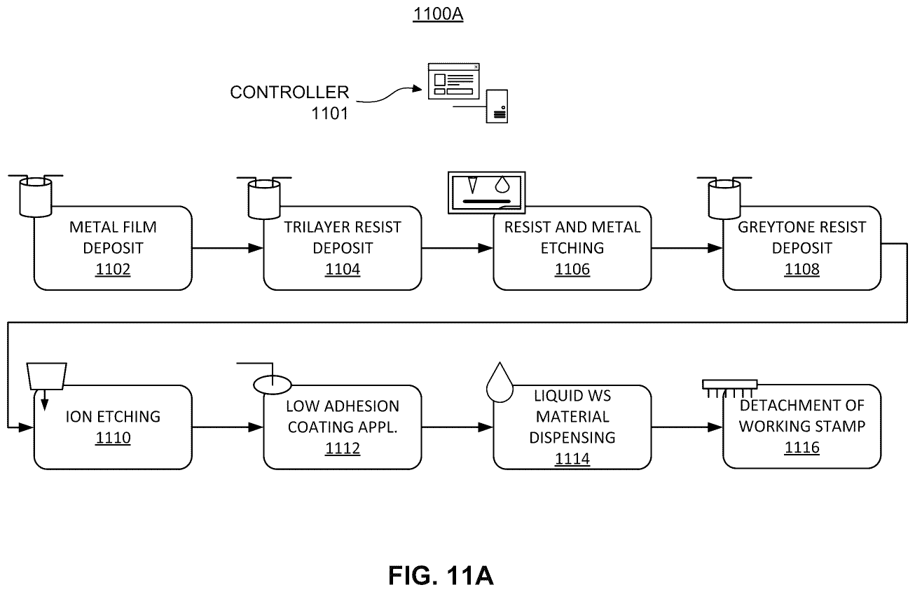

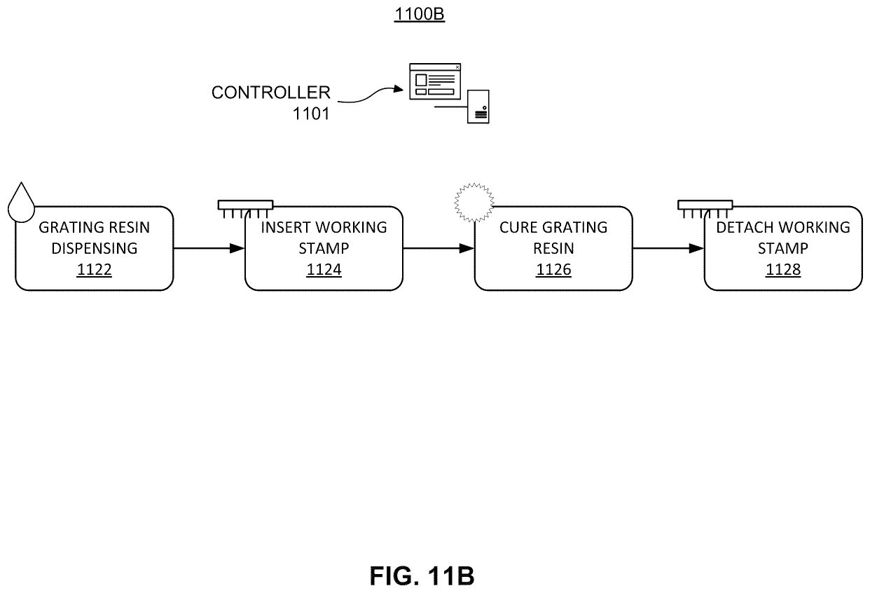

FIGS. 11A-11B illustrate functional block diagrams of a system to fabricate gradient height, slanted waveguide structures using nanoimprint lithography, according to an example.

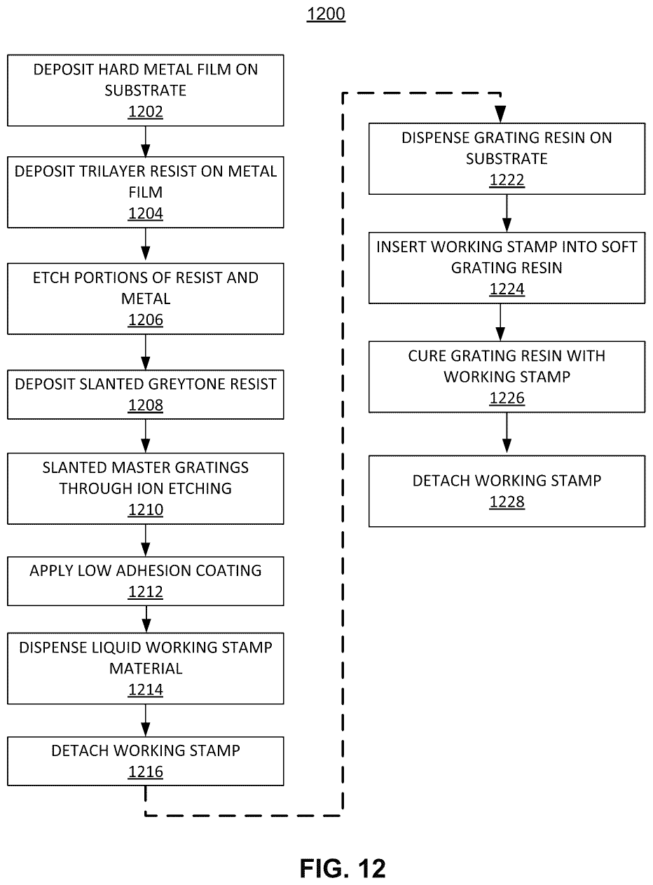

FIG. 12 illustrates a flowchart of a method to fabricate gradient height, slanted waveguide structures using nanoimprint lithography, according to an example.

As discussed herein, optical waveguide structures are used in head-mounted display (HMD) devices and similar near-eye display devices to provide artificial content projection onto a user's eye. To meet size and weight restrictions on wearable augmented reality (AR)/virtual reality (VR) applications, optical waveguide structures are designed and fabricated ever smaller. Conventional nanoimprint lithography manufacturing of waveguides results in constant height waveguide structures. However, the optical performance of waveguides may be improved significantly by having a height gradient in the waveguide structures. Conventional nanoimprint lithography processes are unable to form a three-dimensional (3D) height gradient structures.

Disclosed herein are systems, apparatuses, and methods that may provide fabrication of three dimensional (3D) optical waveguide structures characterized by gradient height and slanted angles. Inkjet nanoimprint lithography (NIL) may be used for producing the final waveguide structure. A nanoimprint lithography master mold (e.g., working stamp master) may be produced from a tri-layer resist. A photolithography process such as grey-tone lithography may be used along with employing a slanted ion-beam etch process to shape the master mold. Low adhesion coating may be used to mechanically detach the master mold.

It should also be appreciated that the systems and methods described herein may be particularly suited for virtual reality (VR), augmented reality (AR), and/or mixed reality (MR) head-mounted display (HMD) environments but may also be applicable to a host of other systems or environments that can utilize optical waveguides. These may include, for example, cameras or sensors, networking, telecommunications, holography, or other optical systems. Thus, the waveguide configurations and their fabrication described herein, may be used in any of these or other examples.

In some examples, an inkjet dispenser may deposit material onto a substrate (e.g., using a precursor material to form the master mold and depositing a grating resin material onto final substrate, etc.). The deposited material may be cured by using the nanoimprint lithography master mold. The cured deposited material may produce a three-dimensional (3D) optical waveguide structure. Additionally, extreme high and low spacing slanted waveguide structures may be produced that are beyond conventional fabrication capabilities.

While some advantages and benefits of the present disclosure are apparent, other advantages and benefits may include fabrication of gradient height slanted waveguide structures that are beyond conventional fabrication capabilities. Optical performance and quality of optical waveguides may also be enhanced. Further, production cost of optical waveguides may be reduced. These and other benefits will be apparent in the description provided herein.

FIG. 8 illustrates a cross section view of simplified version of a head-mounted display (HMD) 800 using tiled optics, according to an example. The cross-section view of the head-mounted display (HMD) 800 may include a rigid body 805 housing various tiled optical components 810 (e.g., lenses, microdisplays, optical waveguides, etc.). The tiled optical components 810 may provide a larger or expanded field of view (FOV) to improve a user's immersive experience. In some examples, the head-mounted display (HMD) 800, as shown, may include a primary optical axis 815 and a tiled optical axis 820, with a plane of symmetry 825 dividing them. To a user's eye 830, the primary optical axis 815 may provide a central field of view (FOV) and the tiled optical axis 820 may provide a peripheral field of view (FOV). It should be appreciated that in some examples, these tiled optical components 810 may be a part of or be included with an electronic display and/or an optics block. Accordingly, these components may include, but not limited to, any number of display devices and/or optical components as described above.

The systems and methods described herein may provide a head-mounted display (HMD) that uses one or more waveguide configurations to reduce overall weight and size. The one or more waveguide configurations described herein may maximize the see-through path by not blocking various optical components, while simultaneously enabling other headset features, such as head/eye tracking components so that they may function at fuller capacities. The waveguide configurations described herein may also improve central and/or peripheral fields of view (FOV) for the user. These and other examples will be described in more detail herein.

As described herein, the systems and methods may use various waveguide configurations in a head-mounted display (HMD) for improved and expanded field of view (FOV) in a more seamlessly way when compared to conventional systems. More specifically, the use of optical waveguide configurations, as described herein, may improve central and peripheral fields of view (FOV) while maintaining high resolution and/or minimizing or eliminating visual distortions. In addition, the systems and methods described herein may reduce the overall form factor of a head-mounted display (HMD), reduce or eliminate any black seam effects created by tiling optics in conventional headsets, obviate any blocked see-through paths, and allow for greater functionality of other built-in features of the headset, such as eye-tracking.

FIGS. 9A-9B illustrate various steps in a conventional height slanted waveguide structure fabrication using an etch process. Diagram 900A includes first four steps in a conventional etching-based waveguide structure fabrication process. At a first step 910, fabrication materials are stacked with a substrate 918 as the bottom layer, a metal thin film layer 916 next, and a polymer imprint resist layer 914 on the metal thin film layer 916. A working stamp 912 may provide the template shaping (stamping) the polymer imprint resist layer 914 into the etching form 922. At step 920, the reduced portions of the polymer imprint resist layer 914 and the metal thin film 916 portions underneath those may be removed by etching. Polymer resist portions on top of the remaining metal thin film portions may be removed at step 930 leaving metal pillars 924 on the substrate 918.

At step 940, a slanted greytone resist layer 926 may be applied fully covering some and partially covering other metal pillars 924 over the substrate 918. A greytone resist mask may be used to transmit only a portion of the incident intensity of light, partially exposing sections of a positive photoresist to a certain depth. This exposure renders the top portion of the photoresist layer more soluble in a developer solution, while the bottom portion of the photoresist layer remains unchanged. The greytone resist layer 926 may be used in combination with Reactive Ion Etching (RIE) or Deep Reactive Ion Etching (DRIE), which allows the resist profiles to be transformed into three-dimensional (3D) structures.

Diagram 900B in FIG. 9B includes step 950, where a slanted beam ion etch 912 may be used to etch slanted structures with variable depth within the substrate 918 between the metal pillars 924. Step 960 in diagram 900B shows the final etched slanted structure 928 with variable etch depth following removal of the remainders of the greytone resist layer 926 and the metal pillars 924. Diagram 900B further includes a microscopy photograph of a slanted waveguide structure 970.

The process flow described in FIG. 9A and 9B may have design limitations in the low and high spacing extremes due to etch loss and due to residual layer thickness-post nanoimprint lithography, which may contribute to spacing limitations. The process may also require multiple steps to form a slanted etch structure and is highly dependent on underlying substrate. Thus, variability in slanted etch performance may result in high variability in resultant optical performance. Underlying slant etch angle may be limited by aspect ratio and shape of metal hard mask. Furthermore, overall high number of process steps may result in higher yield loss.

FIGS. 10A-10C illustrate various steps in a gradient height, slanted waveguide structure fabrication using nanoimprint lithography, according to some examples. FIGS. 10A and 10B show fabrication of a working stamp with variable height slanted structures, whereas FIG. 10C shows the use of the working stamp to form gradient height, slanted waveguide structures.

As shown in FIG. 10A, step 1000A may include preparation of a stack of fabrication materials including master substrate 1002, hard metal thin film layer 1004, and a trilayer spin-coat resist film 1006. In some examples, the master substrate 1002 may be silicon, quartz, glass, silicon carbide, and/or sapphire. The hard metal thin film layer 1004 may be chromium (or alloys thereof) or Titanium Nitride (TiN), and the trilayer resist film 1006 may include, include, but is not limited to, epoxy-based polymer, off-stoichiometry thiol-enes (OSTE) polymer, and hydrogen silses-quioxane (HSQ).

At step 1000B, portions 1016 of the trilayer resist film 1006 and portions 1014 of the hard metal thin film layer 1004 under those may be removed to the surface of the master substrate 1002 through photolithography and hard metal etching. At step 1000C, remaining portions of the trilayer resist film 1006 may be stripped and a slanted greytone resist layer 1018 may be applied fully covering some and partially covering other portions 1014 of the hard metal thin film layer 1004 over the substrate 1002. At step 1000D, a slanted beam ion etch 1020 may be used to etch slanted structures with variable depth within the master substrate 1002 between the portions 1014 of the hard metal thin film layer 1004.

At step 1000E in FIG. 10B, the remaining portions 1014 of the hard metal thin film layer 1004 may be removed (e.g., by stripping) along with any remaining portions of the greytone resist layer 1018 leaving the gradient height, slanted structures 1012 within the master substrate. At step 1000F, inside surfaces of the slanted structures 1012 within the master substrate may be coated with low adhesion coating 1022 providing a working stamp master.

At step 1000G, the slanted structures 1012 within the master substrate coated with the low adhesion coating 1022 may be filled with liquid working stamp material 1024 from an ink dispenser 1026. Working stamp material 1024 may include, but is not limited to, polydimethylsiloxane (PDMS) or Perfluoropolyether (PFPE). At step 1000H, the liquid working stamp material 1024 in the slanted structures 1012 within the master substrate and a layer on top of the substrate may be cured forming the hardened working stamp. The working stamp may then be removed from the master substrate by mechanical detachment.

FIG. 10C shows the use of the working stamp to form gradient height, slanted waveguide structures. At step 10001 in FIG. 10C, grating resin precursor material 1024 may be dispensed by an ink dispenser 1026 over a substrate 1032. The resin may include, but is not limited to, organo-siloxane polymer precursors that cure to form siloxane polymers. At step 1000J, the working stamp 1030 may be inserted into the still soft grating resin precursor material 1024 and the resin cured (1034). The working stamp 1030 may be removed by mechanical detachment at step 1000K leaving gratings 1040 within the cured resin 1034 on the substrate 1032 forming the gradient height, slanted grating waveguide.

In some examples, the hard metal thin film may be deposited by sputtering, physical vapor deposition (PVD), chemical vapor deposition (CVD), atomic layer deposition (ALD), or similar processes on the substrate when fabricating the working stamp. The trilayer resist layer may be applied on the hard metal thin film through spin-coating, plasma deposition, precision droplet-based spraying, etc.

FIGS. 11A-11B illustrate functional block diagrams of a system to fabricate gradient height, slanted waveguide structures using nanoimprint lithography, according to an example. Functional block diagram 1100A includes metal film deposition module 1102, trilayer resist film deposition module 1104, resist and metal film etching module 1106, greytone resist deposition module 1108, ion etching module 1110, low adhesion coating application module 1112, liquid working stamp material dispensing module 1114, detachment module 1116, and controller 1101.

In some examples, a hard thin metal film (e.g., chromium) may be deposited onto a master substrate (e.g., silicon) by the metal film deposition module 1102. A trilayer resist film may be deposited on the hard thin metal film by the trilayer resist film deposition module 1104. The resist and metal film etching module 1106 may remove portions of the trilayer resist film and hard thin metal film through etching. The greytone resist deposition module 1108 may deposit a slanted greytone resist material covering some of the remaining portions of the trilayer resist film and hard thin metal film fully and others partially.

Gradient height, slanted master gratings may be formed by the ion etching module 1110 between the remaining portions of the trilayer resist film and hard thin metal film. Next, the low adhesion coating application module 1112 may apply a thin coat of low adhesion material onto inside surfaces of the master gratings. The liquid working stamp material dispensing module 1114 may be an ink dispenser, for example, and dispense liquid working stamp material into the master gratings coated with low adhesion material. The detachment module 1116 may mechanically detach the cured working stamp from the master gratings.

Functional block diagram 1100B includes grating resin dispensing module 1122, insertion module 1124, curing module 1126, detachment module 1128, and controller 1101. In some examples, liquid grating resin may be deposited over a substrate by the grating resin dispensing module 1122. The working stamp may be inserted into the layer of soft grating resin by the insertion module 1124. The grating resin with the inserted working stamp may be cured at the curing module 1126 and the working stamp removed by the detachment module 1128 leaving the waveguide with the gradient height, slanted gratings.

FIG. 12 illustrates a flowchart of a method to fabricate gradient height, slanted waveguide structures using nanoimprint lithography, according to an example. Each block shown in FIG. 12 may further represent one or more processes, methods, or subroutines, and one or more of the blocks may include machine-readable instructions stored on a non-transitory computer readable medium and executed by a processor or other type of processing circuit to perform one or more operations described herein.

At block 1202, a hard metal thin film layer may be deposited onto a master substrate by the metal film deposition module 1102. At block 1204, a trilayer resist film may be deposited on the hard thin metal film by the trilayer resist film deposition module 1104. At block 1206, the resist and metal film etching module 1106 may remove portions of the trilayer resist film and hard thin metal film through etching. At block 1208, the greytone resist deposition module 1108 may deposit a slanted greytone resist material covering some of the remaining portions of the trilayer resist film and hard thin metal film fully and others partially.

At block 1210, gradient height, slanted master gratings may be formed by the ion etching module 1110 between the remaining portions of the trilayer resist film and hard thin metal film. At block 1212, the low adhesion coating application module 1112 may apply a thin coat of low adhesion material onto inside surfaces of the master gratings. At block 1214, the liquid working stamp material dispensing module 1114 may dispense liquid working stamp material into the master gratings coated with low adhesion material. At block 1216, the detachment module 1116 may mechanically detach the cured working stamp from the master gratings.

In a waveguide fabrication portion of the flowchart, at block 1222, liquid grating resin may be deposited over a substrate by the grating resin dispensing module 1122. At block 1224, the working stamp may be inserted into the layer of soft grating resin by the insertion module 1124. At block 1226, the grating resin with the inserted working stamp may be cured at the curing module 1126. At block 1228, the working stamp removed by the detachment module 1128 leaving the waveguide with the gradient height, slanted gratings.

According to examples, a method of making a gradient height, slanted waveguide structures using nanoimprint lithography is described herein. A system of making the gradient height, slanted waveguide structures using nanoimprint lithography is also described herein. A non-transitory computer-readable storage medium may have an executable stored thereon, which when executed instructs a processor to perform the methods described herein.

### Section III

### Variable Interpupillary Distance (IPD) Multi-Function Test System for Wearable Display Devices

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

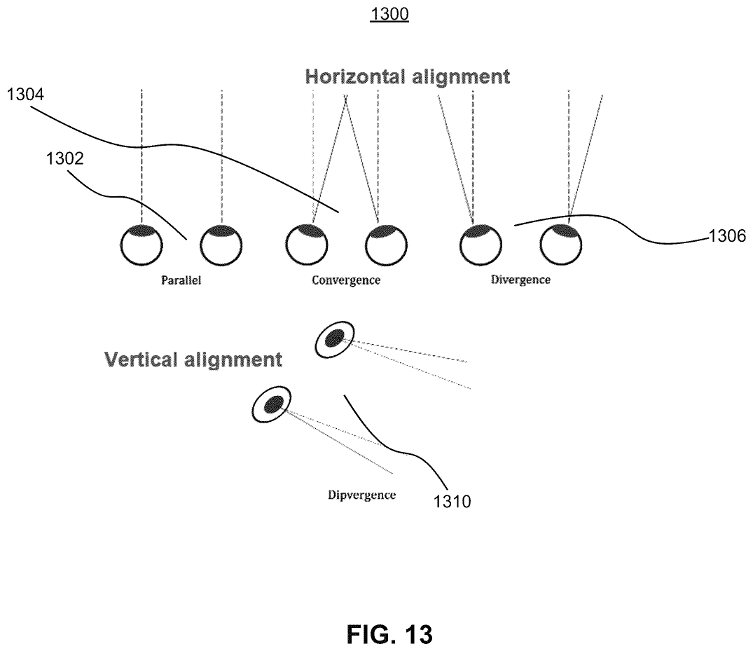

FIG. 13 illustrates various disparities between the lines of sight of the left and right binocular systems.

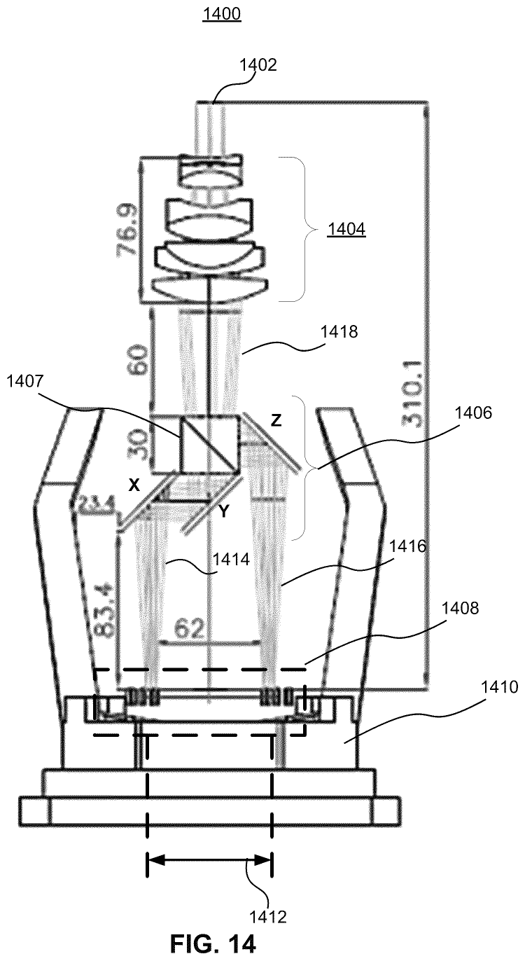

FIG. 14 illustrates a schematic diagram of a variable interpupillary distance (IPD) multi-function periscope, according to some examples.

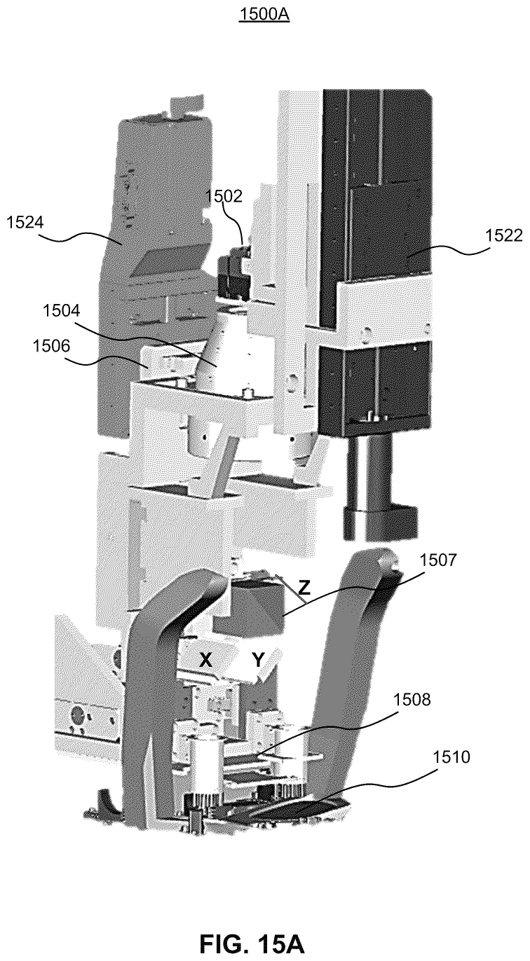

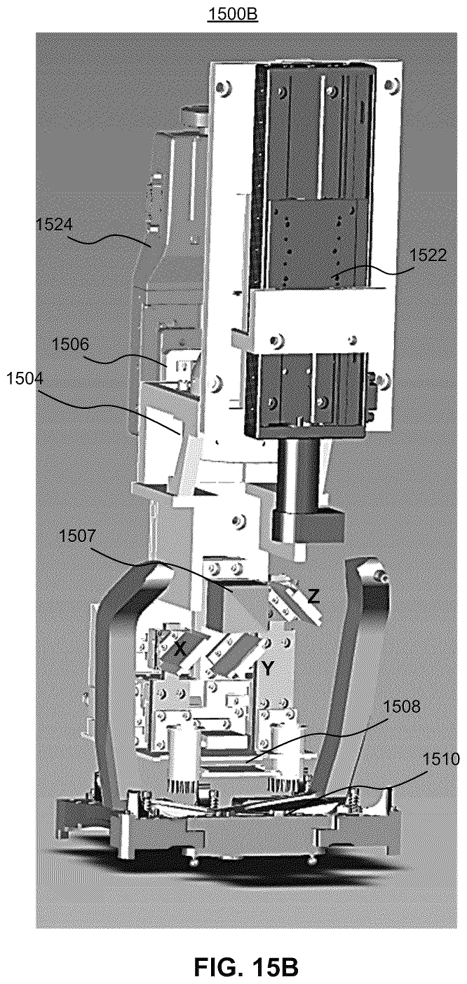

FIG. 15A illustrates a perspective view of a variable interpupillary distance (IPD) multi-function periscope, according to some examples.

FIG. 15B illustrates another perspective view of a variable interpupillary distance (IPD) multi-function periscope, according to some examples.

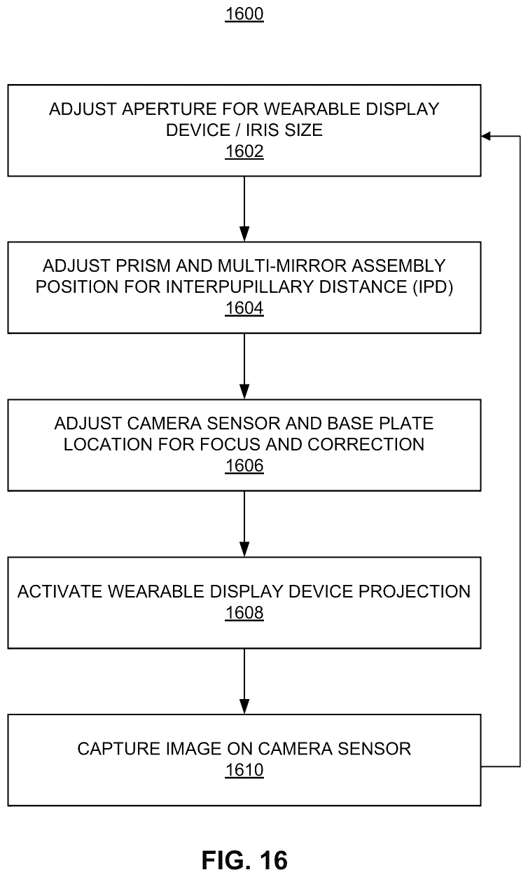

FIG. 16 illustrates a flow diagram of a method for performing disparity and modulation transfer function (MTF) measurement of a near-eye display device in a variable interpupillary distance (IPD) multi-function periscope, according to some examples.

Near-eye display devices such as augmented reality (AR) glasses provide artificial content superimposed with a real environment view. Some implementations of such devices include a transparent display along with any number of optical components (e.g., optical lenses, polarizers, etc.), where the display provides the artificial content to an eye box superimposed with light from the environment passing through the display. In other implementations, a view of the environment may be captured by one or more cameras on an external surface of the augmented reality (AR) glasses and superimposed with the artificial content at the display. When testing a near-eye display device for performance characteristics, a number of aspects such as variable interpupillary distance (IPD), variable presription lenses in the device, different irises, different entrance pupils at iris surface may have to be accomodated.

In some examples of the present disclosure, a variable interpupillary distance (IPD), multi-function test system (periscope) is described. An example periscope may be used for performing disparity and modulation transfer function (MTF) measurement of a near-eye display device. The periscope may include a motorized mechanical assembly to move a folded mirror system to accommodate different interpupillary distances (IPDs), another motorized mechanical assembly to move a camera to accommodate different focus distances and to enable modulation transfer function (MTF) and disparity measurements of near-eye display devices with different prescription corrections. Furthermore, the periscope may be telecentric to maintain optical magnification. The periscope may also allow for different aperture size choices.

While some advantages and benefits of the present disclosure are apparent, other advantages and benefits may include increased reliability and product life for wearable display devices with augmented reality (AR)/virtual reality (VR) functionality, prevention of performance reduction due to misalignment or other manufacturing errors, rapid testing of various types of wearable display devices with custom parameters.

As described herein, wearable display devices (near-eye display devices, head-mounted display (HMD) devices, and similar ones) may have a number of optical and electronic components providing various functions and accommodating differing user needs. For example, interpupillary distances of people may vary. A large portion of the population may have differing visual impairments necessitating prescription lenses or similar corrective measures. Thus, wearable display devices may be customized or customizable to address different users' needs. When such devices are mass-manufactured, calibration and testing may become a challenge. Test fixtures to perform measurements on various aspects of the wearable devices such as disparity and modulation transfer function (MTF) measurements may have to be manually adjusted before each test.

An example variable interpupillary distance (IPD), multi-function test system (periscope) as described herein may include a motorized mechanical assembly to move a folded mirror system to accommodate different interpupillary distances (IPDs), another motorized mechanical assembly to move a camera to accommodate different focus distances and to enable modulation transfer function (MTF) and disparity measurements of near-eye display devices with different prescription corrections. The periscope may be telecentric to maintain optical magnification and may also allow for different aperture size choices.

FIG. 13 illustrates various disparities between the lines of sight of the left and right binocular systems. A periscope test system spatially combines rays incoming from two optical paths (like eyes) to one outgoing optical path with a camera attached to outgoing path to measure disparity of a binocular display. Diagram 1300 shows horizontal alignment between the optical paths of the left and right systems, which may be parallel 1302, convergent 1304, or divergent 1306. In vertical alignment dipvergence 1310 is shown.

While parallel 1302 alignment of optical paths (of both eyes) is the ideal situation, the optical paths in practical implementations may include disparities in an objective gaze-normal plane (a plane perpendicular to the cyclopean line of sight). Convergence 1304 and divergence 1306 are considered in the horizontal alignment plane and may cause focus misalignment. Human vision is not as sensitive to horizontal disparity. However, vertical disparity between the two optical paths (lines of sight), known also as dipvergence 1310, may cause eyestrain. If the vertical disparity (dipvergence 1310) exceeds 30 arc minutes, diplopia and headaches may be experienced. Dipvergence has a positive value when a right image is below a left image.

FIG. 14 illustrates a schematic diagram of a variable interpupillary distance (IPD) multi-function periscope, according to some examples. Diagram 1400 shows components of a periscope test system including a camera sensor 1402, an optical lens assembly 1404, a prism and multi-mirror assembly 1406 with an x-prism 1407 and folded mirrors X, Y, Z, an adjustable aperture 1408 and a wearable display device 1410 under test.

A purpose of the test system is to measure performance of a wearable display device and confirm its operation within predefined parameters, which may include focused display of content, alignment of optical paths, and modulation transfer function. To accommodate wearable display devices with custom characteristics, the test system may include a number of features. For example, the adjustable aperture 1408 may adapt to different size wearable display devices and varying interpupillary distances (IPDs) 1412. A base of the test system may also include a mechanical holder to accommodate various shapes and sizes of wearable devices. The prism and multi-mirror assembly 1406 may combine the separate optical paths 1414 and 1416 from left and right sides into a single path 1418. An optical path distance (OPD) for the separate optical paths 1414 and 1416 may need to be the same to avoid an image from one side to be defocused when an image from the other eye is in focus for a large prescription optical power.

The optical path distance (OPD) equality may be achieved through moving the folded mirrors X (on path 1414) and Z (on the other path 1416) with motors in horizontal direction. The folded mirror Y on path 1414 is fixed with respect to the folded mirrors X and Y. The x-prism 1407 may combine the optical paths 1414 and 1416 into path 1418.

Optical path 1418 may lead to the optical lens assembly 1404, which may normalize prescription or other corrections in the wearable display device. The optical lens assembly 1404 along with the folded mirrors XYZ, and x-Prism 1407 may be installed on the same plate and moved together along a vertical axis of the test system to maintain the same focus distance for different interpupillary distances (IPDs), which enables modulation transfer function (MTF) and disparity measurement with varying optical path distances (OPD) due to IPD change.

Optical path 1418 may lead to the optical lens assembly 1404, which may normalize prescription or other corrections in the wearable display device. The camera sensor 1402 may be moved along a vertical axis of the test system for different focus distances to enable modulation transfer function (MTF) and disparity measurement with varying corrections (i.e., prescription lenses in the wearable display device).

Diagram 1400 also includes example dimensions of various parts of the test system (periscope) in an example implementation. Various components of the test system may be made from suitable materials such as glass or polymer-based materials for the optical lenses, similar materials for the x-prism and mirrors. Mechanical support structure (frame) of the test system may be made from suitable plastic, ceramic, polymer, metal, or metal alloys.

FIG. 15A illustrates a perspective view of a variable interpupillary distance (IPD) multi-function periscope, according to some examples. Diagram 1500A shows an example implementation of a test system (periscope) for wearable display devices with a camera sensor 1502, an optical lens assembly 1504, a prism and multi-mirror assembly with an x-prism 1507 and folded mirrors X, Y, Z, an adjustable aperture 1508 and a wearable display device 1510 under test. The optical lens assembly 1504, a prism and multi-mirror assembly with an x-prism 1507 and folded mirrors X, Y, Z, an adjustable aperture 1508 are installed on a baseplate 1506. The test system further includes a motorized assembly 1524 to move the baseplate 1506 for maintaining the same focus distances when interpupillary distance (IPD) changes and leads to optical path distance change, and a motorized assembly 1522 to move the camera sensor 1502 for different focus distances for varying prescription lenses.

In some examples, the binocular optical path distance (OPD) equality may be achieved through the folded mirrors X, Y (on one path) and Z (on the other path). The x-prism 1507 may combine the optical paths for both eyes into a single path leading to the optical lens assembly 1504. A base of the test system may also include a mechanical holder to accommodate various shapes and sizes of wearable devices.

FIG. 15B illustrates another perspective view of a variable interpupillary distance (IPD) multi-function periscope, according to some examples. Diagram 1500B shows the same components of the test system as in diagram 1500A from a different perspective with the x-prism 1507 and the folded mirrors X, Y, and Z visible.

In some examples, the prism and multi-mirror assembly may combine the separate optical paths from left and right sides into a single path leading to the optical lens assembly 1504. An optical path distance (OPD) for the separate optical paths may need to be the same to avoid an image from one side to be defocused when an image from the other eye is in focus for a large prescription optical power. The optical path distance (OPD) equality may be achieved through the folded mirrors X, Y (on one path) and Z (on the other path). The x-prism 1507 may combine the separate optical paths into the single path. The lens system, the x-prism, and folded mirrors XYZ are installed on a base plate 1506 and may be moved through the motorized assembly 1522 to maintain the same focus distance for wearable display with same prescription lens, when interpupillary distances (IPD) change.

In some example implementations, the interpupillary distance (IPD) range may vary between about 62 mm and about 134 mm depending on the wearable display device type. An entrance pupil (ENP) diameter may have a range between about 3 mm and 12.5 mm. A horizontal field-of-view (FOV) may have a range between −3.5 deg and +3.5 deg, while a vertical field-of-view (FOV) may have a range between −2.5 deg and +2.5 deg. An effective focal length of the test system may be about 114 mm, while an angular resolution may have a range between about 0.36 arcmin and about 1.5 arcmin. A telecentric error may be less than 0.2 arcmin.

FIG. 16 illustrates a flow diagram of a method for performing disparity and modulation transfer function (MTF) measurement of a near-eye display device in a variable interpupillary distance (IPD) multi-function periscope, according to some examples. The method 1600 is provided by way of example, as there may be a variety of ways to carry out the method described herein. Although the method 1600 is primarily described as being performed by the components of FIG. 14, the method 1600 may be executed or otherwise performed by one or more processing components of a test system or a combination of test systems. Each block shown in FIG. 16 may further represent one or more processes, methods, or subroutines, and one or more of the blocks may include machine readable instructions stored on a non-transitory computer readable medium and executed by a processor or other type of processing circuit to perform one or more operations described herein.

At block 1602, an aperture of the test system may be adjusted to accommodate a wearable display device and/or an iris size. As users may have varying iris sizes, wearable display devices may be designed to accommodate different iris sizes.

At block 1604, a lens assembly, prism and multi-mirror assembly position may be adjusted by a motorized assembly to account for varying interpupillary distance (IPD). Users may also have differing interpupillary distances (IPDs). Without accounting for the different interpupillary distances (IPDs), camera may not at the same focus distance when prescription lens is the same, but wearable frame size changes (different IPDs).

At block 1606, a position of the camera sensor and the base plate (with optical lens assembly, x-prism, folded mirrors, and apertures installed onto) of the test system may be adjusted for focus and correction factors that may be in the wearable display device (i.e., prescription lens(es)) due to interpupillary distance (IPD) changes

At block 1608, the wearable display device may be activated and its performance (disparity and modulation transfer function (MTF)) measured with the test system adjusted for the custom aspects of the wearable display device.

At block 1610, one or more images of the wearable display device may be captured by the camera sensor. The images may be analyzed to measure the disparity and modulation transfer function (MTF). The process may be repeated for a different wearable display device performing the adjustments again for the next wearable display device.

According to examples, a method of making a variable interpupillary distance (IPD) multi-function periscope is described herein. A system of making the variable interpupillary distance (IPD) multi-function periscope is also described herein. A non-transitory computer-readable storage medium may have an executable stored thereon, which when executed instructs a processor to perform the methods described herein.

### Section IV

### Parametric Artificial Gratings for a Waveguide Display Architecture

Features of the present disclosure in this section are illustrated by way of example and not limited in the following figures, in which like numerals indicate like elements. One skilled in the art will readily recognize from the following that alternative examples of the structures and methods illustrated in the figures can be employed without departing from the principles described herein.

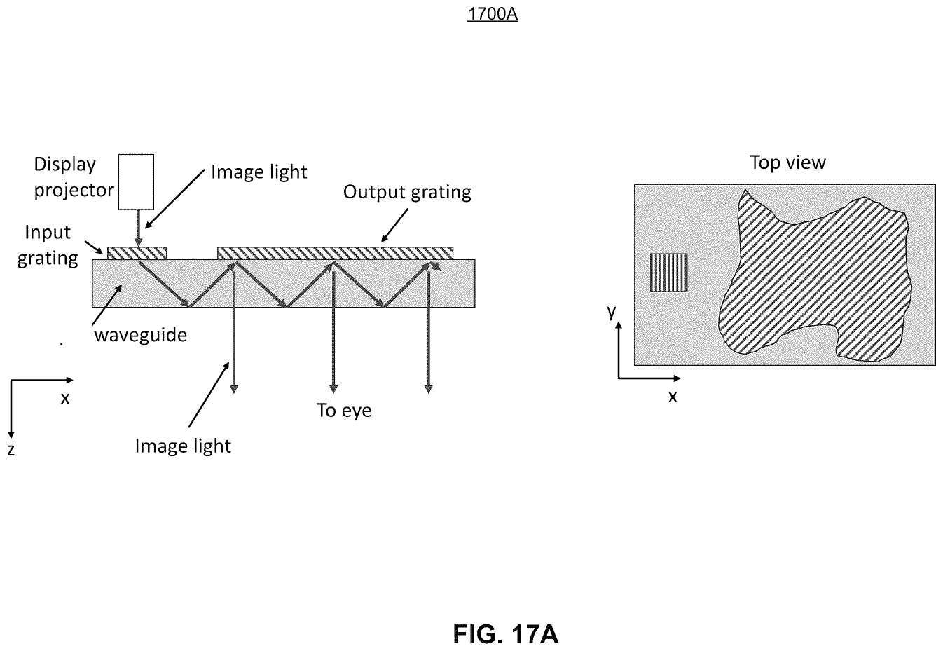

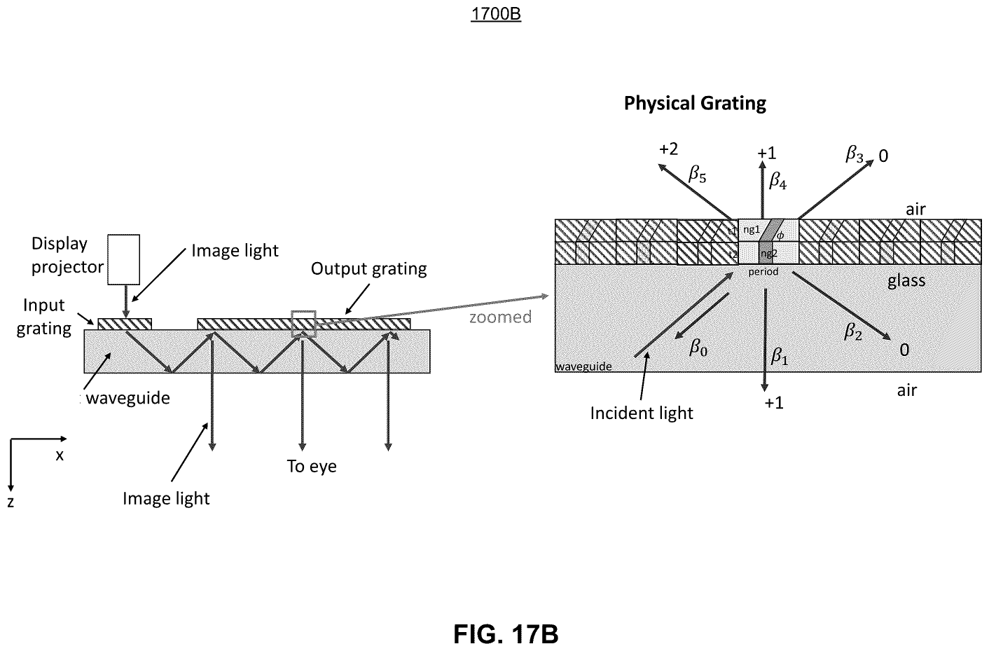

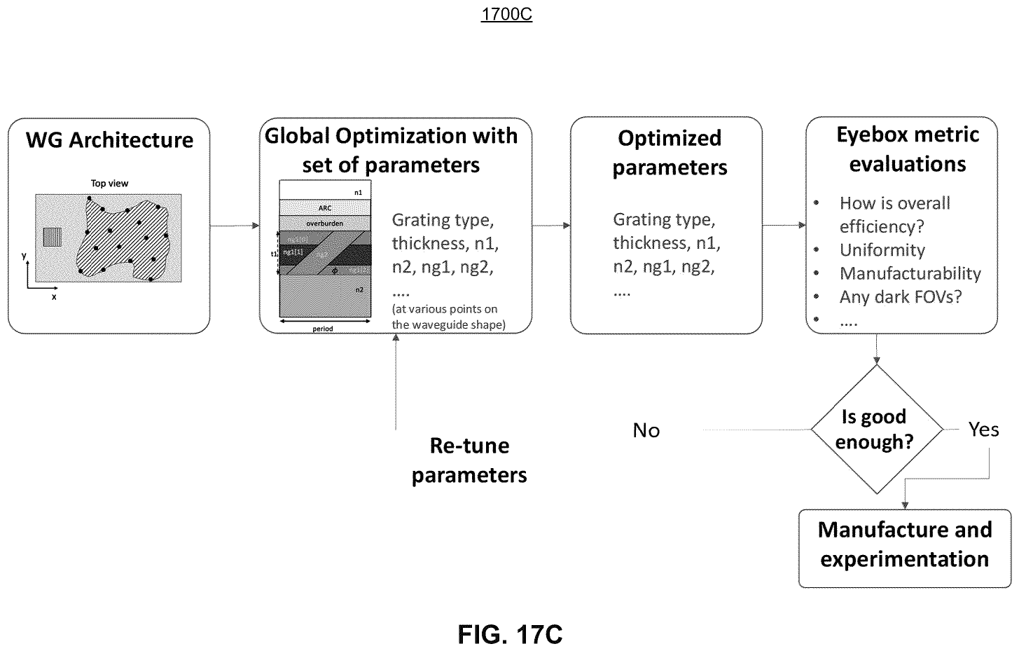

FIG. 17A illustrates a waveguide architecture with physical diffraction gratings, according to examples.

FIG. 17B illustrates diffractions in an enlarged portion of a physical grating.

FIG. 17C illustrates a process of system level design and optimization of a waveguide architecture.

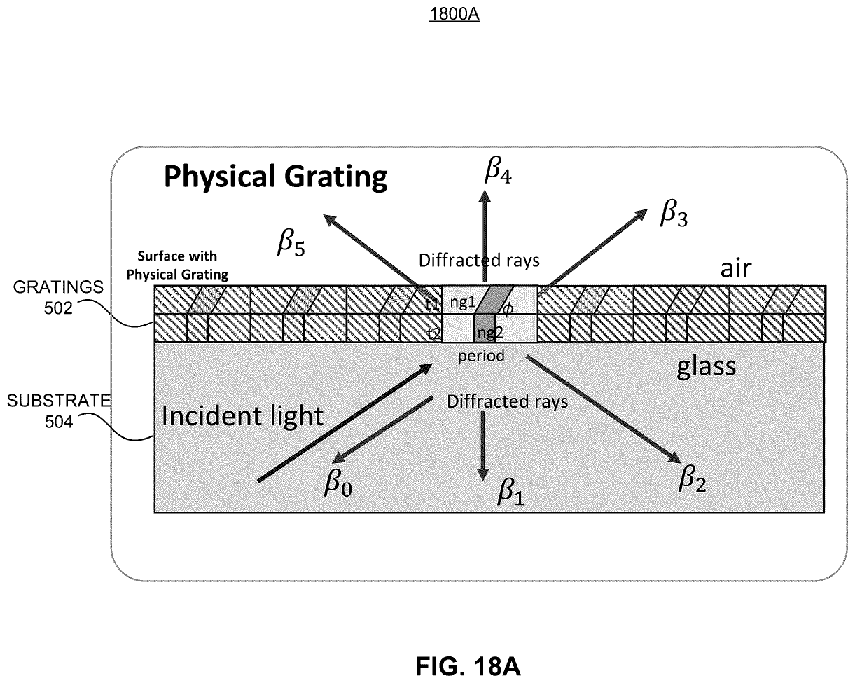

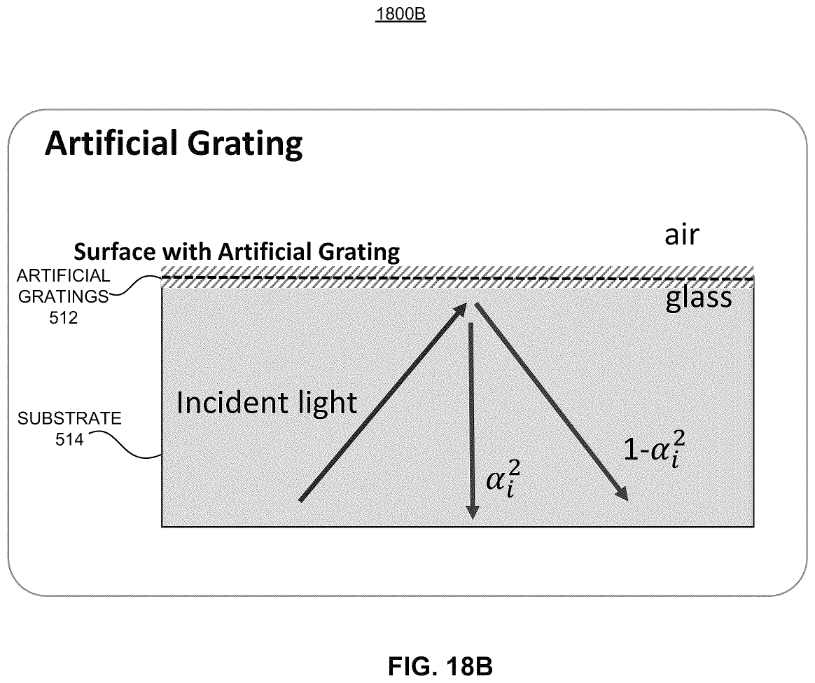

FIGS. 18A and 18B illustrate diffractions in a physical grating and an artificial grating, according to an example.

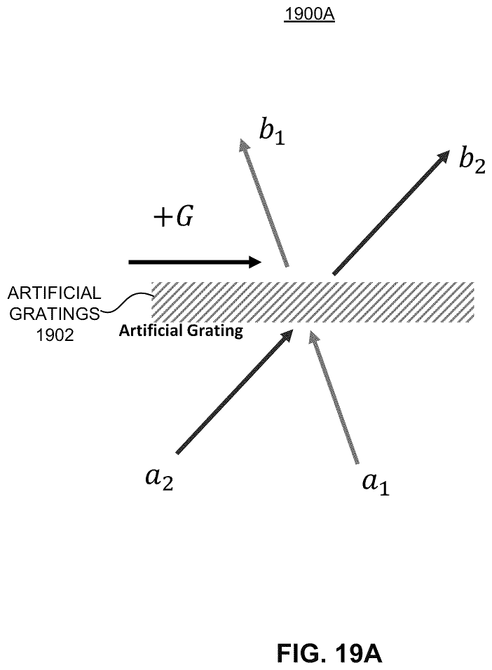

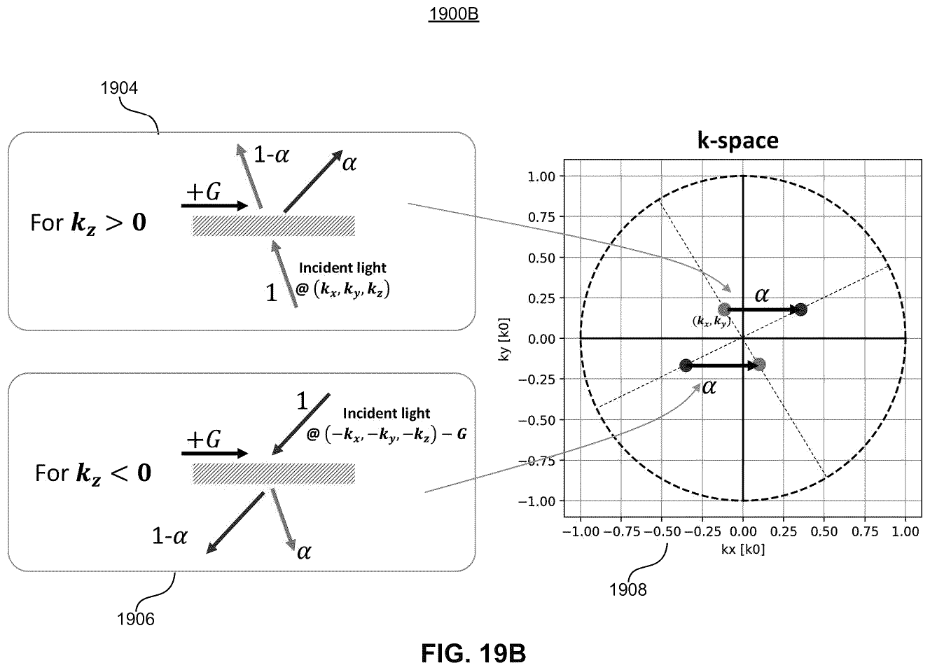

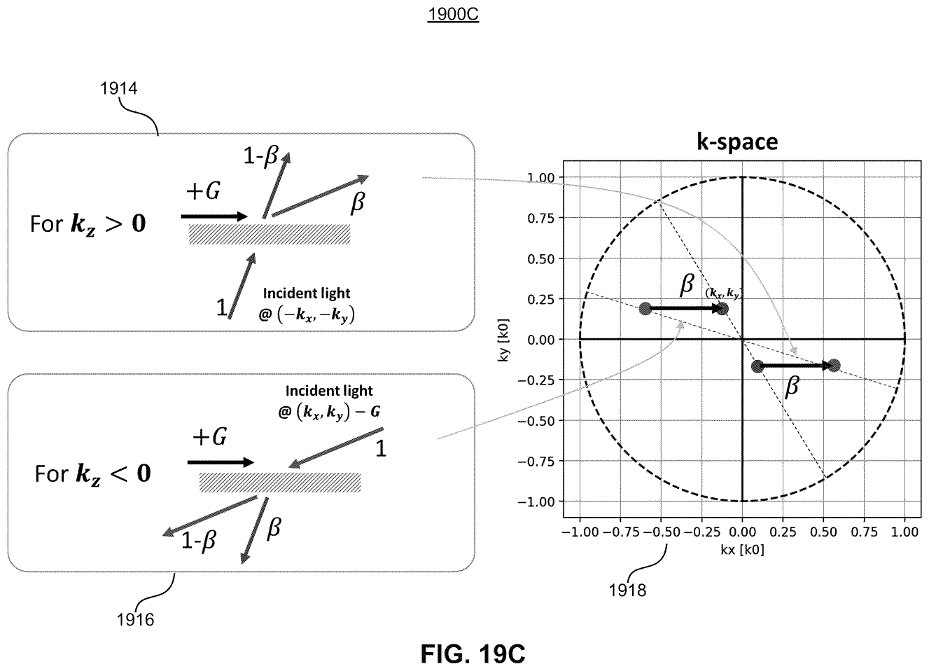

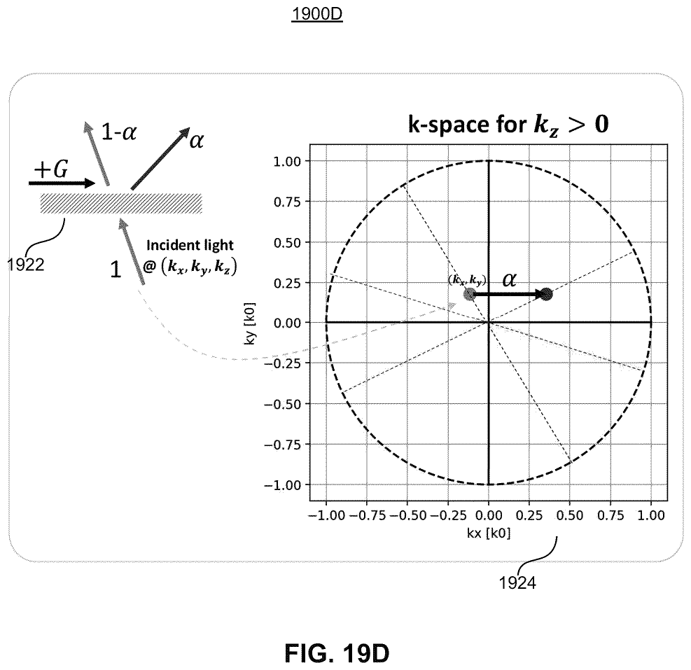

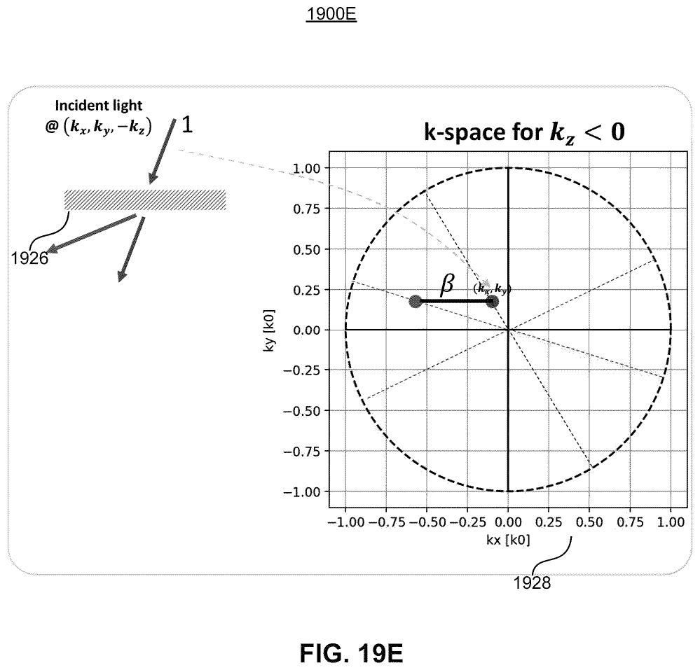

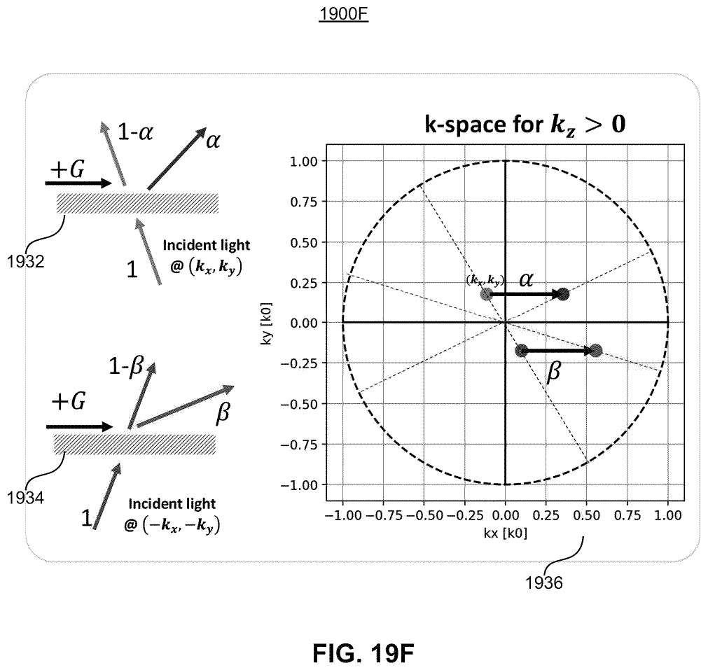

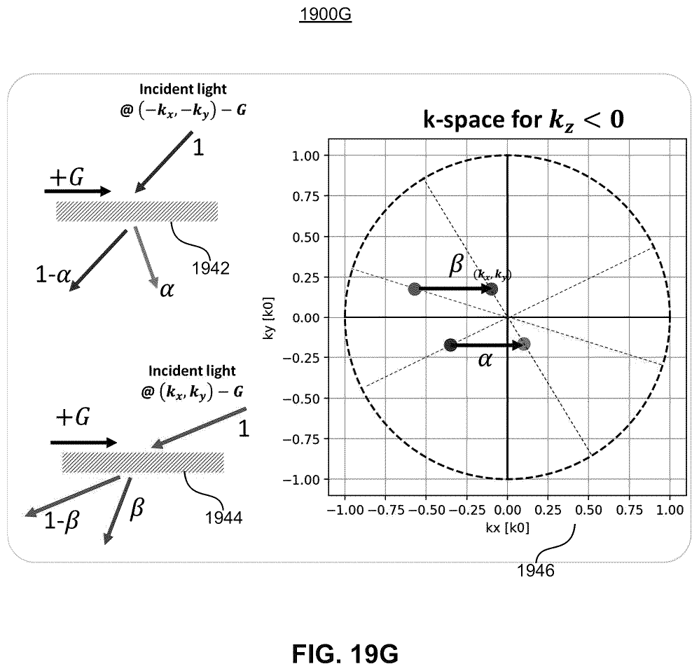

FIGS. 19A through 19G illustrate examples of reciprocity and energy conservation in artificial gratings, according to examples.

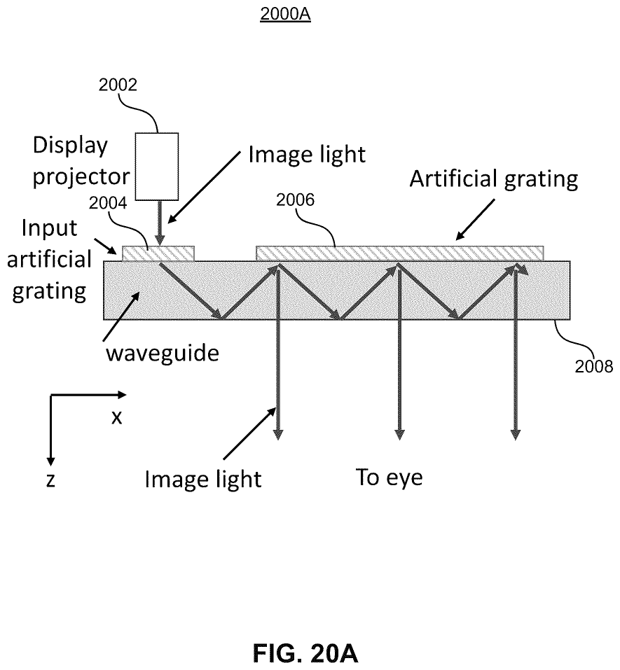

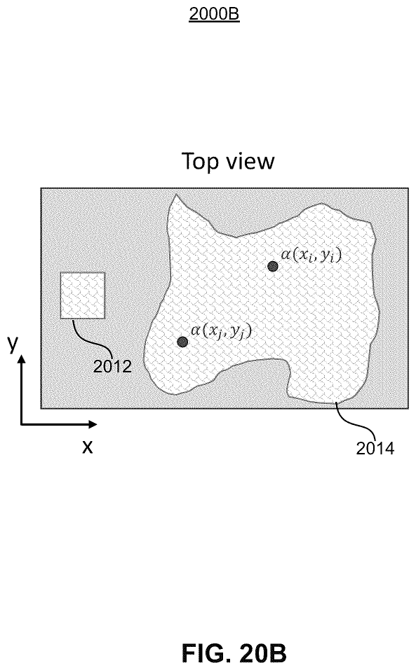

FIG. 20A and 20B illustrate side and top views of artificial gratings to be used in a simulation environment for waveguide architecture, according to examples.

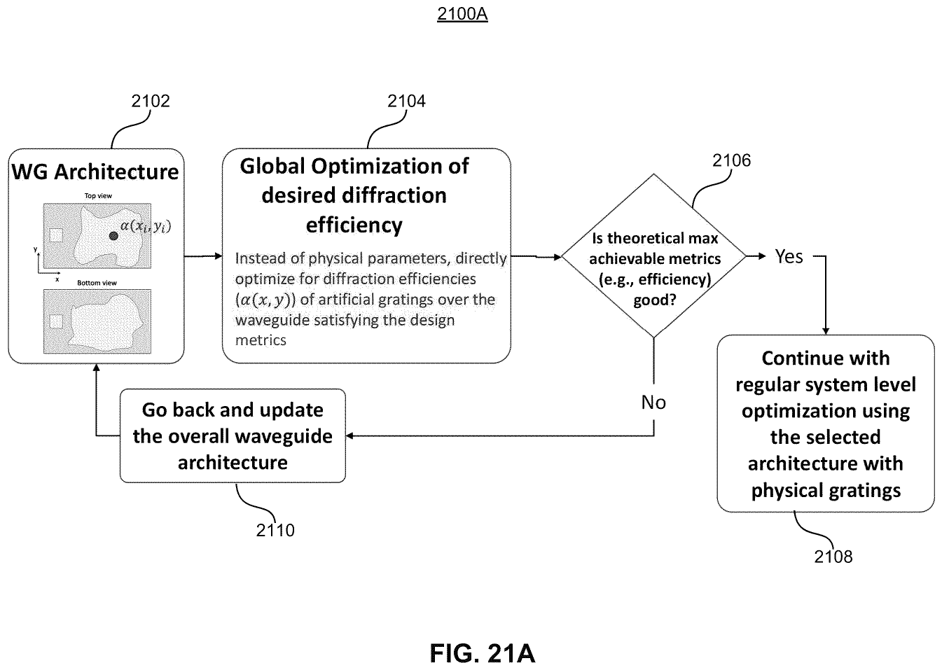

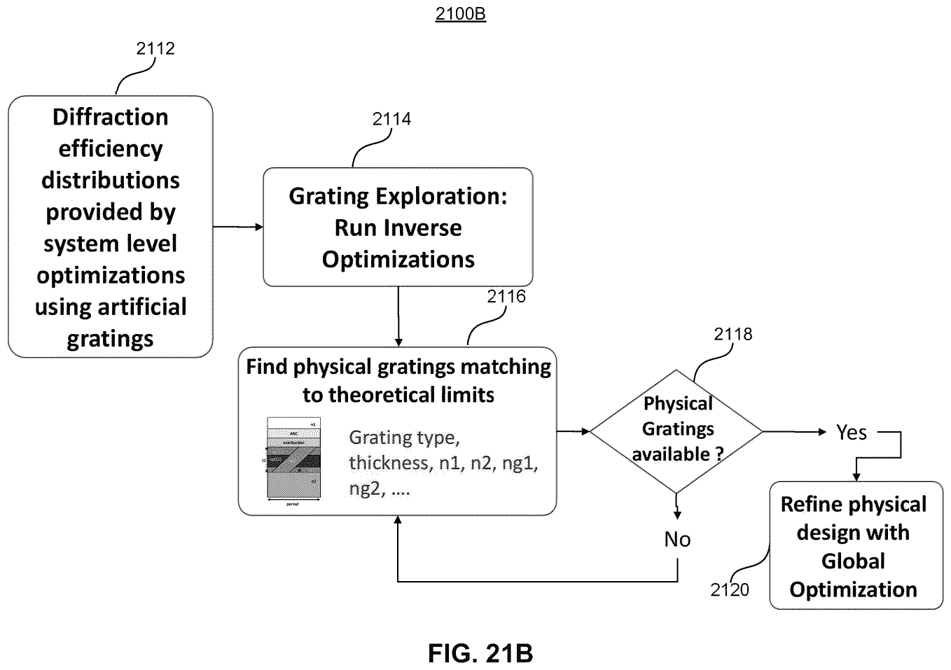

FIG. 21A illustrates a process of performing system level optimizations using a waveguide with artificial gratings to obtain diffraction efficiency distributions over the entire architecture, according to examples.

FIG. 21B illustrates a process of exploring physical gratings to match diffraction efficiency distribution estimation using artificial gratings via inverse optimizations, according to examples.

Waveguide architecture design for augmented reality (AR)/virtual reality (VR) displays involve computationally expensive system-level global optimizations. System-level optimizations can be time-consuming (e.g., weeks) and consume computing capacity for a single architecture resulting in slow design iterations and architecture updates. Furthermore, system-level simulations employ component level simulations at each bounce of the ray within the waveguide. Thus, system-level simulations tend be slow and resource-consuming because of the involvement of many independent component level simulations. Physical gratings may have many parameters to be tuned resulting in a large parameter space. However, corresponding search (design) space is still limited resulting in fewer degrees of freedom in tuning the architectures' diffraction efficiency. Optimization approaches may potentially miss and not consider many other feasible designs. Thus, non-ideal architectures may be selected for prototyping and experimentation. An “optimization” as used herein refers to maximization of diffraction efficiencies for artificial gratings or, in the case of physical gratings, selection of a physical grating with maximum parameter matching for a desired light coupling outcome. Any number of computation techniques such as (but not limited to) genetic algorithms, constrained optimization algorithms, etc. may be used for that purpose.

In some examples of the present disclosure, efficiency of waveguide display architecture design process may be improved by using parametric artificial gratings instead of physical gratings. Artificial diffraction gratings are defined by diffraction efficiency, depend on a few parameters, and are agnostic to the type of the grating, its underlying shape, and material. Artificial diffraction gratings do not require any numerical solvers (in other words component level simulations) and may be extended to multiple channels and orders depending on waveguide architecture. Furthermore, artificial gratings may be utilized to estimate the theoretically achievable key metrics (e.g., efficiency, uniformity) of a given waveguide architecture.

Accordingly, physical gratings may be replaced by parametric artificial gratings in system-level waveguide design optimizations to offer utilization of the entire design space without losing physical constraints of the actual physical gratings by satisfying the reciprocity and energy conservation. Substantially faster system-level optimizations may be performed due to few parameters and avoidance of computationally expensive component level simulators. Furthermore, realistic theoretical limits of a particular waveguide architecture may be estimated.

While some advantages and benefits of the present disclosure are apparent, other advantages and benefits may include substantial reduction of computational resources in waveguide architecture design and estimation of realistic theoretical limits of a particular waveguide architecture.

FIG. 17A illustrates a waveguide architecture with physical diffraction gratings, according to examples. As shown in diagram 1700A, an image light may be provided by a display projector to an input grating of a waveguide. The light diffracted into the waveguide through the input grating may propagate through the waveguide and diffract out toward the eye by output gratings. Diagram 1700A also shows shapes of the input and output gratings in a top view.

Utilized gratings may have any shape depending on the architecture (both input and output gratings). The shapes shown in the diagram are just for illustration purposes. Furthermore, either side of the waveguide may be utilized, and multiple, stacked waveguides and their combinations may also be utilized with or without artificial gratings.

FIG. 17B illustrates diffractions in an enlarged portion of a physical grating. Diagram 1700B shows the physical grating-based waveguide discussed in FIG. 17A and an enlarged portion. The gratings utilized in waveguide architecture involve multiple layers, shapes, etching and thickness of different materials (and other parameters subject to particular design and not mentioned here).

Red arrows in the enlarged physical grating diagram represent the diffracted light from the physical grating where βi represents diffraction efficiencies for each diffracted order. The physical grating can have multiple layers of different materials with different etching properties and thickness characteristics. The shape shown in the diagram is for illustration purposes only.

FIG. 17C illustrates a process of system level design and optimization of a waveguide architecture. Diagram 1700C shows a procedure for system level design and optimization, where waveguide architecture is used for global optimization with a set of parameters, which may be optimized. The optimized parameters may be used for eye box metric evaluations. If an eye box metric is sufficient, the waveguide may be manufactured through experimentation. If the eye box evaluation is sufficient, the parameters may be re-tuned and the process returned to global optimization. Thus, global optimizations involving computationally expensive component level simulations may be used at various control points on the waveguide architecture to achieve desired eye box metrics.

FIGS. 18A and 18B illustrate diffractions in a physical grating and an artificial grating, according to an example. Diagram 1800A shows diffractions in a physical grating, where the red arrows represent the diffracted light by the grating. Computationally expensive component level simulations (both in time and computing power) to find each βi are needed in physical grating-based waveguide design. There is a limited parameter/design space, where βi values can only take a small subset of all available results from 0 to 1. Furthermore, whatever physical ranges allow for the particular selected parameter ranges (e.g., thickness) cannot be too small or large, arbitrary etching may not be used. The design depends on the shape and type of grating.

Diagram 1800B shows diffractions in artificial grating, where diffraction efficiencies and orders are assigned (αi\hat{ }2) at different spatial control points and optimized for. Hence, no component level simulation is needed. An entire design space may be utilized and the artificial grating based design is agnostic to grating type, physical shape, materials or other parameters. Physical interactions governing waveguide expansion (e.g., reciprocity and energy conservation) are kept intact to mimic actual grating behavior. Thus, parametric artificial gratings satisfy the fundamental physical interactions and limitations without physical parameter restrictions. Example techniques incorporate parametric artificial gratings in system level optimization instead of limited physical gratings.

FIGS. 19A through 19G illustrate examples of reciprocity and energy conservation in artificial gratings, according to examples. As mentioned herein, artificial gratings 1902, shown in diagram 1900A of FIG. 19A, keep intact physical interactions governing waveguide expansion, namely reciprocity and energy conservation, to mimic physical grating behavior. The diffraction efficiencies of different orders from artificial gratings may be enforced to satisfy the unitarity for the scattering matrix, which satisfies conservation of energy. As the rays are diffracting, they diffract based on self-consistent physics based on following: the artificial gratings depend only on 5 parameters—depending on the design even fewer parameters may be enough. The scattering matrix for the artificial grating (Aij and ϕij being amplitude and phase, respectively) may be expressed as:

$$( \begin{matrix}{b}_{1} \\ {b}_{2}\end{matrix} ) = ( \begin{matrix}{A}_{11} {e}^{j {ϕ}_{11}} & {A}_{12} {e}^{j {ϕ}_{12}} \\ {A}_{21} {e}^{j {ϕ}_{21}} & {A}_{22} {e}^{j {ϕ}_{22}}\end{matrix} ) ( \begin{matrix}{a}_{1} \\ {a}_{2}\end{matrix} ) = ( \begin{matrix}{α}_{11} & {α}_{12} \\ {α}_{21} & {α}_{22}\end{matrix} ) ( \begin{matrix}{a}_{1} \\ {a}_{2}\end{matrix} ) \\ \overline{b} = {M}^{=} \overline{a} \\ {{M}^{=}}^{H} {M}^{=} = I$$

where the last condition may be enforced for unitarity.

While FIGS. 18B and 19A and associated text above discuss single diffracted rays, the same concept may be applied to other diffraction components at the expense of increased parameters, but still without resource-expensive physical solvers. Required and enforced conditions to satisfy unitarity and energy conservation for the artificial gratings may, thus, include:

A₁₁=\sqrt{1−A₂₁²}(ϕ₁₂−ϕ₁₁)+(ϕ₂₁−ϕ₂₂)=π

A₂₂=\sqrt{1−A₁₂²}ϕ₁₂=ϕ₂₁

A₁₂=A₂₁ϕ₂₂=2ϕ₁₂−ϕ₁₁−π

The final parameters of the artificial gratings to be tuned in the optimizations (other parameters calculated using these) may include: A₁₂, A₂₁ and ϕ₁₂, ϕ₂₁, ϕ₁₁.

Diagram 1900B in FIG. 19B shows how artificial gratings satisfy reciprocity under k_{z}>0 (1904) and k_{z}<0 (1906) conditions, and k-space diagram 1908 with k being the vector amplitude for the incident light (k_{z} being the normal to the surface of the grating). For this purpose, the artificial gratings may be treated as un-even beam-splitters. As shown in the diagrams, artificial gratings take the reciprocity into account while performing beam-splitting. Hence, each grating describes four points on the k-space sphere.

In diagram 1904, diffractions are shown for an artificial grating with a grating vector +G, where the incident light is at (kₓ, k_{y}, k_{z}), and k_{z} is positive. In diagram 1906, diffractions are shown for the same artificial grating with the grating vector +G, where the incident light is at (−kₓ, −k_{y}, −k_{z})−G, and k_{z} is negative. In the k-space diagram 608, each circle corresponds to rays in different directions.

Diagram 1900C in FIG. 19C shows how artificial gratings satisfy reciprocity under k_{z}>0 (1914) and k_{z}<0 (1916) conditions, and k-space diagram 1918. In diagram 1904, diffractions are shown for an artificial grating with a grating vector +G, where the incident light is at (−kₓ, −k_{y}), and k_{z} is positive. In diagram 1906, diffractions are shown for the same artificial grating with the grating vector +G, where the incident light is at (kₓ, k_{y})−G, and k_{z} is negative.

Diagrams 1900D and 1900E in FIGS. 19D and 19E, respectively, show how artificial gratings guarantee reciprocity, where (kₓ, k_{y}, k_{z}) is independent from (kₓ, k_{y}, −k_{z}) and reflected rays at the same field of view (FoV) are described by a different diffraction efficiency. In diagram 1900D, an artificial grating 1922 with a grating vector +G is used, where the incident light is at (kₓ, k_{y}, k_{z}), and k_{z} is positive as shown in k-space diagram 1924. In diagram 1900E, an artificial grating 1926 with a grating vector +G is used, where the incident light is at (kₓ, k_{y}, −k_{z}), and k_{z} is negative as shown in k-space diagram 1928.

Diagrams 1900F and 1900G in FIGS. 19F and 19G, respectively, show how artificial gratings guarantee reciprocity, where each field of view (FOV) requires eight points on the k-space sphere. Optimization of (kₓ, k_{y}) and (−kₓ, −k_{y}) field of views (FOVs) are coupled, where each grating specifies the diffraction efficiencies at those field of views (FOVs). In diagram 1900F, artificial gratings 1932 and 1934 with grating vectors +G are used, where the incident light is at (kₓ, k_{y}) and (−kₓ, −k_{y}), respectively, and k_{z} is positive as shown in k-space diagram 1936. In diagram 1900G, artificial gratings 1942 and 1944 with grating vectors +G are used, where the incident light is at (−kₓ, −k_{y})−G and (kₓ, k_{y})−G, respectively, and k_{z} is negative as shown in k-space diagram 1946.

FIG. 20A and 20B illustrate side and top views of artificial gratings to be used in a simulation environment for waveguide architecture, according to examples.

Diagram 2000A, shows a side view of a waveguide with artificial grating similar to FIG. 17A. An image light may be provided by a display projector 2002 to an input grating 2004 of a waveguide 2008. The light diffracted into the waveguide 2008 through the input grating 2004 may propagate through the waveguide 2008 and diffract out toward the eye by output gratings 2006. In a simulation environment, the initial waveguide architecture and the layout/outlines of each waveguide may be maintained, replacing the physical grating components on the waveguides with the artificial grating components. Diagram 2000B shows shapes of the input grating 2012 and output gratings 2014 in a top view.

FIG. 21A illustrates a process of performing system level optimizations using a waveguide with artificial gratings to obtain diffraction efficiency distributions over the entire architecture, according to examples.

Diagram 2100A shows system level optimizations using waveguide with artificial gratings. Diffraction efficiency distributions related to artificial grating parameters α(x, y) may be obtained over the whole architecture for desired metrics. With artificial gratings, computationally expensive component level simulations are not needed. Hence, system level optimizations to update the waveguide architecture and obtain key metrics are much faster than physical grating simulations. A design iteration process may also be accelerated.

As shown in the diagram, the process may begin with waveguide architecture 2102 (top and bottom views of example architectures are shown), followed by global optimization of desired diffraction efficiency 2104. In the optimization, optimization may be performed directly for diffraction efficiencies (α(x,y)) of artificial gratings over the waveguide satisfying the design metrics instead of physical parameters. If the theoretical maximum achievable metric (e.g., efficiency) is satisfactory (2106), the process may continue with regular system level optimization using the selected architecture with physical gratings 2108. If the theoretical maximum achievable metric (e.g., efficiency) is not satisfactory (2106), the process may return to the beginning and update the overall waveguide architecture.

FIG. 21B illustrates a process of exploring physical gratings to match diffraction efficiency distribution estimation using artificial gratings via inverse optimizations, according to examples.

Diagram 2100B shows a process of physical gratings exploration to match diffraction efficiency distribution estimations via inverse optimizations, where the diffraction efficiency distribution estimations are obtained through the process in FIG. 21A using artificial gratings. This approach may allow a designer to select appropriate gratings and parameters (search space) for subsequent actual global optimization.

As shown in the diagram, the process may begin with diffraction efficiency distributions provided by system level optimizations using artificial gratings 2112, followed by grating exploration 2114, where inverse optimizations may be executed. Physical gratings matching the theoretical limits may be searched at step 2116. If physical gratings are available (2118), the physical design may be refined with global optimization 2120. If no physical gratings are available (2118), the process may return to searching the physical gratings that match the theoretical limits 816.

The processes in diagrams 2100A and 2100B are provided by way of example, as there may be a variety of ways to carry out the methods described herein. Although the methods discussed herein may be primarily described as being performed by certain components such as computers, servers, etc., the methods may be executed or otherwise performed by one or more processing components of another system or a combination of systems. Each block shown in the processes of FIGS. 21A and 21B may further represent one or more processes, methods, or subroutines, and one or more of the blocks may include machine readable instructions stored on a non-transitory computer readable medium and executed by a processor or other type of processing circuit to perform one or more operations described herein.

In some examples, parametric artificial gratings may be used in place of physical gratings to accelerate waveguide architecture design lifecycle. Artificial gratings only depend on a few design parameters and are agnostic to a type of the grating, its underlying shape, material and other parameters, computation of which may result in much slower numerical simulations if the physical gratings are utilized in waveguide architecture design. Artificial gratings are defined only by their diffraction efficiencies and not by any other physical parameters (e.g., thickness, material property, etc.). Hence, an entire design space may be searched, which may not be practical using physical gratings. Physical interactions governing the waveguide expansion (e.g., reciprocity and energy conservation) may be kept intact to provide realistic theoretical limits of the architecture. The design approach may be extended to multiple channels and orders depending on the waveguide architecture. Artificial gratings may also be used to estimate the theoretically achievable key metrics (e.g., efficiency, uniformity) of a given waveguide architecture. Subsequently, the results may be used to obtain physical gratings via inverse optimizations. Additionally, initial point and design space for global optimization may be improved utilizing physical gratings.

According to examples, a method of designing waveguide architectures using artificial gratings is described herein. A system of designing waveguide architectures using artificial gratings is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. An optical assembly, comprising:
a display to provide artificial content to an eye box;
one or more optical elements, wherein
the display and the one or more optical elements are aligned along a primary optical axis of the eye box, and
at least one surface of the display or the one or more optical elements is treated with an ultraviolet (UV) blocking coating.

2. The optical assembly of claim 1, wherein at least one other surface of the display or the one or more optical elements is treated with an infrared (IR) blocking coating.

3. The optical assembly of claim 1, wherein at least one other surface of the display or the one or more optical elements is treated with a photochromic coating.

4. The optical assembly of claim 3, wherein the photochromic coating comprises microcrystalline silver halides in a glass optical element or dioxazines, benzoxazines, or naphthopyrans in a plastic optical element.

5. The optical assembly of claim 1, wherein the ultraviolet (UV) blocking coating comprises transparent conductive oxide (TCO), aluminum doped zinc oxide (AZO), indium tin oxide (ITO), or indium zinc oxide (IZO).

6. The optical assembly of claim 1, wherein the one or more optical elements comprise an optical lens, a polarizer, an optical correction lens, or a phase plate.

7. The optical assembly of claim 1, wherein the display or the one or more optical elements are separated by an airgap.

8. The optical assembly of claim 1, wherein the display comprises a liquid crystal display (LCD), a light-emitting diode (LED) display, or a waveguide display.

9. An augmented reality (AR) near-eye display device, comprising:
a frame containing one or more optical components and one or more electrical components; and
an optical assembly supported by the frame, the optical assembly comprising:
a display to provide artificial content to an eye box;
one or more optical elements, wherein
the display and the one or more optical elements are aligned along a primary optical axis of the eye box, and
at least one surface of the display or the one or more optical elements is treated with an ultraviolet (UV) blocking coating.

10. The augmented reality (AR) near-eye display device of claim 9, wherein at least one other surface of the display or the one or more optical elements is treated with a photochromic coating.

11. The augmented reality (AR) near-eye display device of claim 10, wherein the photochromic coating comprises microcrystalline silver halides in a glass optical element or dioxazines, benzoxazines, or naphthopyrans in a plastic optical element.

12. The augmented reality (AR) near-eye display device of claim 9, wherein the one or more optical elements comprise a first virtual reality (VR) lens and a second virtual reality (VR) lens.

13. The augmented reality (AR) near-eye display device of claim 9, wherein the one or more optical elements further comprise a polarizer, an optical correction lens, or a phase plate.

14. The augmented reality (AR) near-eye display device of claim 9, wherein the ultraviolet (UV) blocking coating comprises transparent conductive oxide (TCO), aluminum doped zinc oxide (AZO), indium tin oxide (ITO), or indium zinc oxide (IZO).

15. The augmented reality (AR) near-eye display device of claim 9, wherein at least one other surface of the display or the one or more optical elements is treated with an infrared (IR) blocking coating.

16. A method for assembling an optical assembly for a near-eye display device, the method comprising:
selecting one or more surfaces of a display or one or more optical elements of the optical assembly to be treated with a protective coating;
applying the coating to the selected one or more surfaces; and
assembling the optical assembly by aligning the display and the one or more optical elements along a primary optical axis and fitting into a mechanical support structure, wherein
the primary axis is the primary axis of an eye box onto which the display is to project artificial content.

17. The method of claim 16, wherein the protective coating is a photochromic coating comprising microcrystalline silver halides in a glass optical element or dioxazines, benzoxazines, or naphthopyrans in a plastic optical element.

18. The method of claim 16, wherein the protective coating is an ultraviolet (UV) blocking coating comprising transparent conductive oxide (TCO), aluminum doped zinc oxide (AZO), indium tin oxide (ITO), or indium zinc oxide (IZO).

19. The method of claim 16, wherein the protective coating is an infrared (IR) blocking coating.

20. The method of claim 16, wherein the display comprises a liquid crystal display (LCD), a light-emitting diode (LED) display, or a waveguide display.
